(19) United States
(12) Patent Application Publication
(10) Pub. No.: US 2009/0167157 A1
(43) Pub. Date: Jul. 2, 2009

(54) ORGANIC ELECTROLUMINESCENT DEVICE

(76) Inventors: Takeshi Murakami, Kanagawa (JP); Toshihiro Ise, Kanagawa (JP); Tatsuya Igarashi, Tokyo (JP)

Correspondence Address: BIRCH STEWART KOLASCH & BIRCH, PO BOX 747, FALLS CHURCH, VA, 22040-0747, US

(21) Appl. No.: 12/067,546

(22) PCT Filed: Sep. 21, 2006
(86) PCT No.: PCT/JP2006/319225

§ 371 Date: Mar. 20, 2008

(30) Foreign Application Priority Data
Sep. 21, 2005 (JP) 2005-274248

(51) Int. Cl. H01J 1/63; C07F 15/00

(52) U.S. Cl. 313/504; 546/4; 544/225

(57) ABSTRACT

An organic electroluminescent device is provided and has an organic layer between a pair of electrodes, the organic layer containing a compound represented by formula (I).

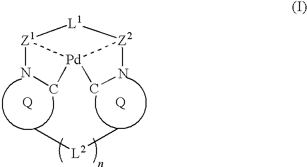

Z¹ and Z² each represent an atom group coordinating with palladium; Q represents a nitrogen-containing heterocycle; L¹ and L² each represent a single bond or a divalent linking group; and n is 0 or 1.

### TECHNICAL FIELD

This invention relates to a light-emitting device capable of converting electrical energy into light and thus emitting light, in particular, an organic electroluminescent device (hereinafter, sometimes referred to as “EL device”).

### BACKGROUND ART

Vigorous research and development have been made on organic electroluminescent devices which can achieve a high luminance at a low driving voltage. In an organic electroluminescent device which has an organic layer between a pair of electrodes, electrons injected from the cathode are re-bonded to holes injected from the anode in the organic layer and the energy of excitons thus formed is utilized in light emission.

In recent years, attempts have been made to elevate the efficiency of such devices by using phosphorescent materials. There have been known devices using an iridium complex, a platinum complex and so on as light-emitting materials (see, for example, U.S. Pat. No. 6,303,238 and WO 00/57676). However, it is still required to improve these devices in durability.

Concerning a means of improving the driving durability of a device, there has been reported a light-emitting device, in which a metal complex is employed as a charge-transporting material (see, for example, JP-A-2004-221065). However, it is still required to further improve such an element in efficiency and durability.

### DISCLOSURE OF THE INVENTION

An object of an illustrative, non-limiting embodiment of the invention is to provide a material for organic electroluminescent devices, in particular, a complex compound that is suitable as an electron-transporting material. Another object of an illustrative, non-limiting embodiment of the invention is to provide an organic electroluminescent device having an excellent durability.

The inventors conducted intensive studies to attain the above-described objects. As a result, they have found that the objects can be attained by an organic electroluminescent device containing a quadridentate ligand complex having a specific structure in its organic layer. Accordingly, the invention can be completed by the following means.

(1) An organic electroluminescent device comprising:

a pair of electrodes; and

at least one organic layer between the pair of electrodes, the at least one organic layer containing a compound represented by formula (I):

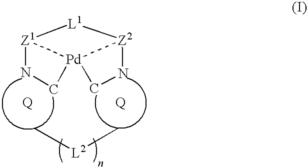

wherein Z¹ and Z² each independently represent an atom group coordinating with palladium; Q represents a nitrogen-containing heterocycle; L¹ and L² each independently represent a single bond or a divalent linking group; and n is 0 or 1.
(2) The organic electroluminescent device as described in the above (1), wherein the compound represented by formula (I) is a compound represented by formula (II):

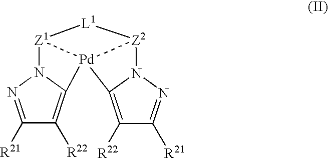

wherein Z¹, Z² and L¹ are the same as those defined in formula (I); and R²¹s and R²²s each independently represent a hydrogen atom or a substituent.
(3) The organic electroluminescent device as described in the above (1), wherein the compound represented by formula (I) is a compound represented by formula (III):

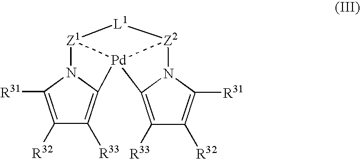

wherein Z¹, Z² and L¹ are the same as those defined in formula (I); and R³¹s, R³²s and R³³s each independently represent a hydrogen atom or a substituent.
(4) The organic electroluminescent device as described in the above (1), wherein the compound represented by formula (I) is a compound represented by formula (IV):

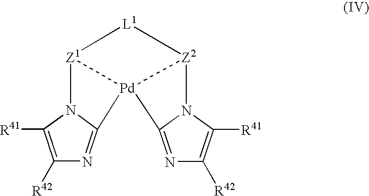

wherein Z¹, Z² and L¹ are the same as those defined in formula (I); and R⁴¹s and R⁴²s each independently represent a hydrogen atom or a substituent.
(5) The organic electroluminescent device as described in the above (2), wherein the compound by formula (II) is a compound represented by formula (IIA):

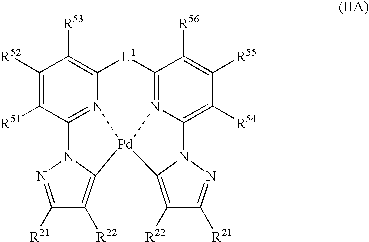

wherein L¹ represents a single bond or a divalent linking group; and R²¹s, R²²s, R⁵¹, R⁵², R⁵³, R⁵⁴, R⁵⁵ and R⁵⁶ each independently represent a hydrogen atom or a substituent.
(6) The organic electroluminescent device as described in the above (5), wherein the compound represented by formula (IIA) is a compound represented by formula (IIB):

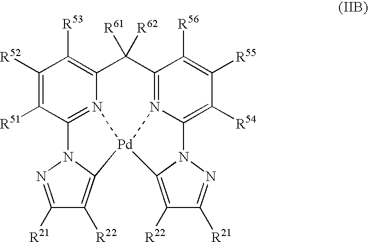

wherein R²¹s, R²²s, R⁵¹, R⁵², R⁵³, R⁵⁴, R⁵⁵, R⁵⁶, R⁶¹ and R⁶² each independently represent a hydrogen atom or a substituent.
(7) The organic electroluminescent device as described in the above (6), wherein the compound represented by formula (IIB) is a compound represented by formula (IIC):

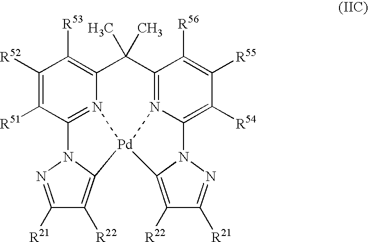

wherein R²¹s, R²²s, R⁵¹, R⁵², R⁵³, R⁵⁴, R⁵⁵ and R⁵⁶ each independently represent a hydrogen atom or a substituent.
(8) The organic electroluminescent device as described in the above (7), wherein the compound represented by formula (IIC) is a compound represented by formula (IID):

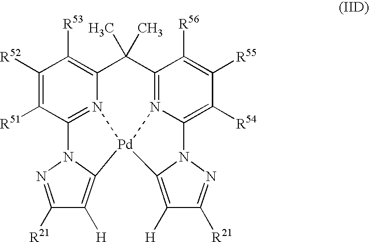

wherein R⁵¹, R⁵², R⁵³, R⁵⁴, R⁵⁵ and R⁵⁶ each independently represent a hydrogen atom or a substituent; and R²¹s each represent a substituent.
(9) The organic electroluminescent device as described in any one of the above (2) to (8), wherein the substituent is a substituent selected from the group consisting of an alkyl group having from 1 to 20 carbon atoms, an alkenyl group having from 2 to 10 carbon atoms, an aryl group having from 6 to 20 carbon atoms, an amino group having from 0 to 20 carbon atoms, an alkoxy group having from 1 to 20 carbon atoms, an aryloxy group having from 6 to 20 carbon atoms, an acyl group having form 1 to 20 carbon atoms, an alkoxycarbonyl group having from 2 to 20 carbon atoms, an alkylthio group having from 1 to 20 carbon atoms, a sulfonyl group having from 1 to 20 carbon atoms, a hydroxy group, a halogen atom, a cyano group, a nitro group and a 5- to 7-membered heterocycle.
(10) A compound represented by formula (IIA):

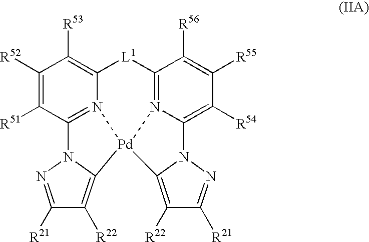

wherein L¹ represents a single bond or a divalent linking group; and R²¹s, R²²s, R⁵¹, R⁵², R⁵³, R⁵⁴, R⁵⁵ and R⁵⁶ each independently represent a hydrogen atom or a substituent.
(11) The compound as described in the above (10), wherein R²¹s, R²²s, R⁵¹, R⁵², R⁵³, R⁵⁴, R⁵⁵ and R⁵⁶ each independently represent a substituent selected from the group consisting of an alkyl group having from 1 to 20 carbon atoms, an alkenyl group having from 2 to 10 carbon atoms, an aryl group having from 6 to 20 carbon atoms, an amino group having from 0 to 20 carbon atoms, an alkoxy group having from 1 to 20 carbon atoms, an aryloxy group having from 6 to 20 carbon atoms, an acyl group having form 1 to 20 carbon atoms, an alkoxycarbonyl group having from 2 to 20 carbon atoms, an alkylthio group having from 1 to 20 carbon atoms, a sulfonyl group having from 1 to 20 carbon atoms, a hydroxy group, a halogen atom, a cyano group, a nitro group and a 5- to 7-membered heterocycle.

### DETAILED DESCRIPTION OF THE INVENTION

Although the invention will be described below with reference to the exemplary embodiments thereof, the following exemplary embodiments and modifications do not restrict the invention.

According to an exemplary embodiment of the invention, by adding a complex represented by any one of the formulae (I) to (IV) and the formulae (IIA) to (IID) to an organic layer, it becomes possible to provide an organic electroluminescent device (hereinafter used in the same meaning as “device of the invention”) having an excellent durability.

The definition of the substituent group A as used herein is as follows.

### (Substituent Group A)

Alkyl groups (preferably having from 1 to 30 carbon atoms, still preferably from 1 to 20 carbon atoms and particularly preferably from 1 to 10 carbon atoms, such as methyl, ethyl, isopropyl, tert-butyl, n-octyl, n-decyl, n-hexadecy, cyclopropyl, cyclopentyl and cyclohexyl groups), alkenyl groups (preferably having from 2 to 30 carbon atoms, still preferably from 2 to 20 carbon atoms and particularly preferably from 2 to 10 carbon atoms, such as vinyl, allyl, 2-butenyl and 3-pentenyl groups), alkynyl groups (preferably having from 2 to 30 carbon atoms, still preferably from 2 to 20 carbon atoms and particularly preferably from 2 to 10 carbon atoms, such as propargyl and 3-pentynyl groups), aryl groups (preferably having from 6 to 30 carbon atoms, still preferably from 6 to 20 carbon atoms and particularly preferably from 6 to 12 carbon atoms, such as phenyl, p-methylphenyl, naphthyl and anthranyl groups), amino groups (preferably having from 0 to 30 carbon atoms) still preferably from 0 to 20 carbon atoms and particularly preferably from 0 to 10 carbon atoms, such as amino, methylamino, dimethylamino, diethylamino, dibenzylamino, diphenylamino and ditolylamino groups), alkoxy groups (preferably having from 1 to 30 carbon atoms, still preferably from 1 to 20 carbon atoms and particularly preferably from 1 to 10 carbon atoms, such as methoxy, ethoxy, butoxy and 2-ethylhexyloxy groups), aryloxy groups (preferably having from 6 to 30 carbon atoms, still preferably from 6 to 20 carbon atoms and particularly preferably from 6 to 12 carbon atoms, such as phenyloxy, 1-naphthyloxy and 2-naphthyloxy groups), heterocyclic oxy groups (preferably having from 1 to 30 carbon atoms, still preferably from 1 to 20 carbon atoms and particularly preferably from 1 to 12 carbon atoms, such as pyridyloxy, pyrazyloxy, pyrimidyloxy and quinolyloxy groups), acyl groups (preferably having from 1 to 30 carbon atoms, still preferably from 1 to 20 carbon atoms and particularly preferably from 1 to 12 carbon atoms, such as acetyl, benzoyl, formyl and pivaloyl groups), alkoxycarbonyl groups (preferably having from 2 to 30 carbon atoms, still preferably from 2 to 20 carbon atoms and particularly preferably from 2 to 12 carbon atoms, such as methoxycarbonyl and ethoxycarbonyl groups), aryloxycarbonyl groups (preferably having from 7 to 30 carbon atoms, still preferably from 7 to 20 carbon atoms and particularly preferably from 7 to 12 carbon atoms, such as a phenyloxycarbonyl group), acyloxy groups (preferably having from 2 to 30 carbon atoms, still preferably from 2 to 20 carbon atoms and particularly preferably from 2 to 10 carbon atoms, such as acetoxy and benzoyloxy groups), acylamino groups (preferably having from 2 to 30 carbon atoms, still preferably from 2 to 20 carbon atoms and particularly preferably from 2 to 10 carbon atoms, such as acetylamino and benzoylamino groups), alkoxycarbonylamino groups (preferably having from 2 to 30 carbon atoms, still preferably from 2 to 20 carbon atoms and particularly preferably from 2 to 12 carbon atoms, such as a methoxycarbonylamino group), aryloxycarbonylamino groups (preferably having from 7 to 30 carbon atoms, still preferably from 7 to 20 carbon atoms and particularly preferably from 7 to 12 carbon atoms, such as a phenyloxycarbonylamino group), sulfonylamino groups (preferably having from 1 to 30 carbon atoms, still preferably from 1 to 20 carbon atoms and particularly preferably from 1 to 12 carbon atoms, such as methanesulfonylamino and benzenesulfonylamino groups), sulfamoyl groups (preferably having from 0 to 30 carbon atoms, still preferably from 0 to 20 carbon atoms and particularly preferably from 0 to 12 carbon atoms, such as sulfamoyl, methylsulfamoyl, dimethylsulfamoyl and phenylsulfamoyl groups), carbamoyl groups (preferably having from 1 to 30 carbon atoms, still preferably from 1 to 20 carbon atoms and particularly preferably from 1 to 12 carbon atoms, such as carbamoyl, methylcarbamoyl, diethylcarbamoyl and phenylcarbamoyl groups), alkylthio groups (preferably having from 1 to 30 carbon atoms, still preferably from 1 to 20 carbon atoms and particularly preferably from 1 to 12 carbon atoms, such as methylthio and ethylthio groups), arylthio groups (preferably having from 6 to 30 carbon atoms, still preferably from 6 to 20 carbon atoms and particularly preferably from 6 to 12 carbon atoms, such as a phenylthio group), heterocyclic thio groups (preferably having from 1 to 30 carbon atoms, still preferably from 1 to 20 carbon atoms and particularly preferably from 1 to 12 carbon atoms, such as pyridylthio, 2-benzimidazolylthio, 2-benzimidazolylthio and 2-benzithiazolylthio groups), sulfonyl groups (preferably having from 1 to 30 carbon atoms, still preferably from 1 to 20 carbon atoms and particularly preferably from 1 to 12 carbon atoms, such as mesyl and tosyl groups), sulfinyl groups (preferably having from 1 to 30 carbon atoms, still preferably from 1 to 20 carbon atoms and particularly preferably from 1 to 12 carbon atoms, such as methanesulfinyl and benzenesulfinyl groups), ureido groups (preferably having from 1 to 30 carbon atoms, still preferably from 1 to 20 carbon atoms and particularly preferably from 1 to 12 carbon atoms, such as ureido, methylureido and phenylureido groups), phosphoramido groups (preferably having from 1 to 30 carbon atoms, still preferably from 1 to 20 carbon atoms and particularly preferably from 1 to 12 carbon atoms, such as diethylphosphoramido and phenylphosphoramido groups), a hydroxyl group, a mercapto group, halogen atoms (for example, a fluorine atom, a chlorine atom, a bromine atom and an iodine atom), a cyano group, a sulfo group, a carboxyl group, a nitro group, a hydroxamate group, a sulfino group, a hydrazino group, an imino group, heterocyclic groups (preferably having from 1 to 30 carbon atoms, still preferably from 1 to 12 carbon atoms, and the hetero atom being, for example, a nitrogen atom, an oxygen atom or a sulfur atom, such as imidazolyl, pyridyl, quinolyl, furyl, thienyl, piperidyl, morpholino, benzoxazolyl, benzimidazolyl, benzthiazolyl, carbazolyl and azepinyl groups), silyl groups (preferably having from 3 to 40 carbon atoms, still preferably from 3 to 30 carbon atoms and particularly preferably from 3 to 24 carbon atoms, such as trimethylsilyl and triphenylsilyl groups), silyloxy groups (preferably having from 3 to 40 carbon atoms, still preferably from 3 to 30 carbon atoms and particularly preferably from 3 to 24 carbon atoms, such as trimethylsilyloxy and triphenylsilyloxy groups) and so on. These substituents may be further substituted.

In the formulae (I) to (IID), it is preferable that R²¹s, R²²s, R³¹, R³², R³³, R⁴¹, R⁴², R⁵¹, R⁵², R⁵³, R⁵⁴, R⁵⁵, R⁵⁶, R⁶¹ and R⁶² each independently represent a substituent selected from the substituent group A as described above, still preferably a substituent selected from the group consisting of an alkyl group having from 1 to 20 carbon atoms, an alkenyl group having from 2 to 10 carbon atoms, an aryl group having from 6 to 20 carbon atoms, an amino group having from 0 to 20 carbon atoms, an alkoxy group having from 1 to 20 carbon atoms, an aryloxy group having from 6 to 20 carbon atoms, an acyl group having form 1 to 20 carbon atoms, an alkoxycarbonyl group having from 2 to 20 carbon atoms, an alkylthio group having from 1 to 20 carbon atoms, a sulfonyl group having from 1 to 20 carbon atoms, a hydroxy group, a halogen atom, a cyano group, a nitro group and a 5- to 7-membered heterocycle.

Next, a device of the invention will be described in greater detail.

A device of the invention has at least one organic layer between a pair of electrodes. A device of the invention may have a pair of electrode (the cathode and the anode) on a substrate and an organic layer sandwiched between these electrodes. Taking the nature of the device into consideration, it is preferable that at least one of the electrodes (the cathode and the anode) is transparent.

A device of the invention contains a quadridentate ligand complex having a specific structure in its organic layer. Although the “at least one organic layer” is not particularly restricted in function, it may be a light-emitting layer or a hole-injecting layer, a hole-transporting layer, an electron-injecting layer, an electron-transporting layer, a hole-blocking layer, an electron-blocking layer, an exciton-blocking layer, a protective layer, etc. Moreover, the device of the invention may have a hole-injecting layer, a hole-transporting layer, an electron-injecting layer; an electron-transporting layer, a hole-blocking layer, an electron-blocking layer, an exciton-blocking layer, a protective layer, etc., in addition to the at least one organic layer. Each of these layers may have other additional function(s).

Concerning the layer structure of the organic layers in the invention, it preferably comprises a hole-transporting layer, a light-emitting layer and an electron-transporting layer in this order from the anode side. Further, it may have an electron-blocking layer or the like between the hole-transporting layer and the light-emitting layer or between the light-emitting layer and the electron-transporting layer. It may have a hole-injecting layer between the anode and the hole-transporting layer and an electron-injecting layer between the cathode and the electron-transporting layer. Each layer may be composed of multiple sublayers.

In the case where the organic layer is composed of multiple layers, a complex of the invention may be contained in any layer (a hole-injecting layer, a hole-transporting layer, an exciton-blocking layer, a light-emitting layer, a hole-blocking layer, an electron-transporting layer or an electron-injecting layer). It is preferable that the complex is contained in the electron-injecting layer, the electron-transporting layer or the light-emitting layer, still preferably in the electron-transporting layer or the light-emitting layer. It is particularly preferable that the complex is contained as a host material in the light-emitting layer.

In the case where the organic layer contains a compound represented by formula (I), the amount of the compound is preferably from 0.1 to 50% by mass (weight), still preferably from 0.2 to 30% by mass, still preferably from 0.3 to 20% by mass, and most preferably from 0.5 to 15% by mass, based on the total layer mass.

The term “host material” means a compound contained together with a light-emitting material in the light-emitting layer. It is preferably a compound having the functions of injecting and transporting charge in the light-emitting layer. It is also preferable that the host material per se has substantially no light-emitting property. The expression “substantially having no light-emitting property” as used herein means that the luminescence dose from the compound substantially having no light-emitting property is preferably 5% or less, still preferably 3% or less and still preferably 1% or less based on the total luminescence from the whole device.

Although the concentration of the host material in the light-emitting layer is not particularly restricted, it is preferable that the host material is the main component (the component contained in the largest amount) in the light-emitting layer. It is more preferable that the content thereof is 50 to 99.9% by mass, still preferably 70 to 99.8% by mass, still preferably 80 to 99.7% by mass, and most preferably 90 to 99.5% by mass.

The glass transition temperature of the host material is preferably 100 to 500° C., still preferably 110 to 300° C. and still preferably 120 to 250° C.

The fluorescent wavelength of the host material in a state where the host material is contained in the light-emitting layer is preferably 400 to 650 nm, still preferably 420 to 600 nm and still preferably 440 to 550 nm.

As the host material contained in the light-emitting layer of the invention, a metal complex according to the invention (i.e., a compound represented by formula (I)) can be used. It is also possible to employ, as the host material, one or more compounds selected from the compounds described in the paragraphs [0113] to [0161] in JP-A-2002-100476 and the compounds described in paragraphs [0087] to [0098] in JP-A-2004-214179 together with the metal complex according to the invention. The host material to be used together with the metal complex according to the invention is not particularly restricted.

Now, the complex represented by the formula (I) will be illustrated. In the formula (I), Z¹ and Z² each independently represent an atom group coordinating with palladium. Although Z¹ and Z² are not particularly restricted, so long as being an atom group coordinating with palladium, an atom group including a carbon atom at which the group coordinates with palladium, an atom group including a nitrogen atom at which the group coordinates with palladium, an atom group including an oxygen atom at which the group coordinates with palladium, an atom group including a sulfur atom at which the group coordinates with palladium and an atom group including a phosphorous atom at which the group coordinates with palladium are preferred. Among those, the atom group including a carbon atom, the atom group including a nitrogen atom and the atom group including an oxygen atom are still preferred, and the atom group including a carbon atom and the atom group including a nitrogen are still preferred.

As examples of the atom group including a carbon atom, there can be enumerated an imino group, aromatic hydrocarbon ring groups (benzene, naphthalene and so on), heterocyclic groups (thiophene, pyridine, pyrazine, pyrimidine, pyridazine, triazine, thiazole, oxazole, pyrrole, imidazole, pyrazole, triazole and so on), fused rings containing the same and tautomers thereof. Such a group may further have a substituent. As examples of the substituent, the groups illustrated concerning the substituent group A can be cited.

As examples of the atom group including a nitrogen atom, there can be enumerated nitrogen-containing heterocyclic group (pyridine, pyrazine, pyrimidine, pyridazine, triazine, thiazole, oxazole, pyrrole, imidazole, pyrazole, triazole and so on), amino groups (alkylamino groups (preferably having from 2 to 30 carbon atoms, still preferably from 2 to 20 carbon atoms and particularly preferably from 2 to 10 carbon atoms such as methylamino), arylamino groups (for example, phenylamino), acylamino groups (preferably having from 2 to 30 carbon atoms, still preferably from 2 to 20 carbon atoms and particularly preferably from 2 to 10 carbon atoms such as acetylamino and benzoylamino), alkocycarbonylamino groups (preferably having from 2 to 30 carbon atoms, still preferably from 2 to 20 carbon atoms and particularly preferably from 2 to 12 carbon atoms such as methoxycarbonylamino), aryloxycarbonylamino group (preferably having from 7 to 30 carbon atoms, still preferably form 7 to 20 carbon atoms and particularly preferably from 7 to 12 carbon atoms such as phenyloxycarbonylamino), sulfonylamino groups (preferably having from 1 to 30 carbon atoms, still preferably from 1 to 20 carbon atoms and particularly preferably from 1 to 12 carbon atoms such as methanesulfonylamino and benzenesulfonylamino), an imino group and so on. Such a group may further have a substituent. As examples of the substituent, the groups illustrated concerning the substituent group A can be cited.

As examples of the atom group including an oxygen atom, there can be enumerated alkoxy groups (preferably having from 1 to 30 carbon atoms, still preferably from 1 to 20 carbon atoms and particularly preferably from 1 to 10 carbon atoms such as methoxy, ethoxy, butoxy and 2-ethylhexyloxy), aryloxy groups (preferably having from 6 to 30 carbon atoms, still preferably from 6 to 20 carbon atoms and particularly preferably from 6 to 12 carbon atoms such as phenyloxy, 1-naphthyloxy and 2-naphthyloxy), heterocyclic oxy groups (preferably having from 1 to 30 carbon atoms, still preferably from 1 to 20 carbon atoms and particularly preferably from 1 to 12 carbon atoms such as pyridyloxy, pyrazyloxy, pyrimidyloxy and quinolyloxy), acyloxy groups (preferably having from 2 to 30 carbon atoms, still preferably from 2 to 20 carbon atoms and particularly preferably from 2 to 10 carbon atoms such as acetoxy and benzoyloxy), silyloxy groups (preferably having from 3 to 40 carbon atoms, still preferably from 3 to 30 carbon atoms and particularly preferably from 3 to 24 carbon atoms such as trimethylsilyloxy and triphenylsilyloxy), carbonyl groups (for example, ketone groups, ester groups and amide groups), ether groups (for example, dialkyl ether groups, diaryl ether groups and a furyl group) and so on. Such a group may further have a substituent. As examples of the substituent, the groups illustrated concerning the substituent group A can be cited.

As examples of the atom group including a sulfur atom, there can be enumerated alkylthio groups (preferably having from 1 to 30 carbon atoms, still preferably from 1 to 20 carbon atoms and particularly preferably from 1 to 12 carbon atoms such as methylthio and ethylthio), arylthio groups (preferably having from 6 to 30 carbon atoms, still preferably from 6 to 20 carbon atoms and particularly preferably from 6 to 12 carbon atoms such as phenylthio), heterocyclic thio groups (preferably having from 1 to 30 carbon atoms, still preferably from 1 to 20 carbon atoms and particularly preferably from 1 to 12 carbon atoms such as pyridylthio, 2-benzimizolylthio, 2-benzoxazolylthio and 2-benzthiozolylthio), thiocarbonyl groups (for example, thioketone groups and thioester groups), thioether groups (for example, dialkyl thioether groups, diaryl thioether groups and thiofuryl groups) and so on. Such a group may further have a substituent. As examples of the substituent, the groups illustrated concerning the substituent group A can be cited.

As examples of the group including a phosphorus atom, there can be enumerated dialkylphosphino groups, diarylphosphino groups, trialkylphosphines, triarylphosphines, a phosphinine group and so on. Such a group may further have a substituent. As examples of the substituent, the groups illustrated concerning the substituent group A can be cited.

It is preferable that Z¹ and Z² each represent an atom group including a nitrogen atom at which the group coordinates with palladium, an atom group including an oxygen atom at which the group coordinates with palladium or an atom group including a phosphorus atom at which the group coordinating with palladium, still preferably the group including a nitrogen atom, still preferably a nitrogen-containing heterocyclic group coordinating with palladium at the nitrogen atom therein, and particularly preferably a monocyclic nitrogen-containing heterocyclic group coordinating with palladium at the nitrogen atom therein.

In the case where Z¹ and Z² are monocyclic nitrogen-containing heterocyclic groups, specific examples thereof include pyridine, pyrazine, pyrimidine, pyridazine and triazine. Pyridine, pyrazine and pyrimidine are still preferred, pyridine, pyrazine are still preferred and pyridine is particularly preferred.

If possible, Z¹ and Z² may have substituents selected from the substituent group A.

Preferable examples of the substituents which may be carried by Z¹ and Z² include alkyl groups, aryl groups, amino groups, alkoxy groups, aryloxy groups, acyl groups, alkoxycarbonyl groups, alkylthio groups, sulfonyl groups, a hydroxy group, halogen atoms, a cyano group, a nitro group and heterocyclic groups.

If possible, Z¹ and Z² may form together with another ring a fused ring. As examples of the ring to be fused together, there can be enumerated a benzene ring, a pyridine ring, a pyrazine ring, a pyrimidine ring, a pyridazine ring, a thiophene ring, a furan ring, a pyrrole ring, an imidazole ring, a pyrazole ring, a triazole ring, an oxazole ring, a thiazole ring, an oxadiazole ring and a thiadiazole ring.

Q represents a nitrogen-containing heterocycle which may be formed with a carbon atom and a nitrogen atom in a group Z¹-N—C—Pd (or Z²-N—C—Pd). As Q, there can be enumerated substituted or unsubstituted triazole, pyrrole, pyrazole, imidazole and so on. Substituted or unsubstituted pyrazole is preferred, pyrazole having a substituent at the 3-position is still preferable, pyrazole having an alkyl group or a cyano group at the 3-position is still preferable and pyrazole having a trifluoromethyl group, a t-butyl group or a cyano group is particularly preferable.

If possible, Q may have a substituent and the substituent has the same meaning as the substituent group A. As the substituent of Q, an alkyl group, an aryl group, a heterocyclic group and a cyano group are preferred, an alkyl group and a cyano group are still preferred, and a trifluoromethyl group, a t-butyl group and a cyano group are particularly preferred.

If possible, Q may form together with another ring a fused ring. As examples of the ring to be fused together, there can be enumerated a benzene ring, a pyridine ring, a pyrazine ring, a pyrimidine ring, a pyridazine ring, a thiophene ring, a furan ring, a pyrrole ring, an imidazole ring, a pyrazole ring, a triazole ring, an oxazole ring, a thiazole ring, an oxadiazole ring and a thiadiazole ring.

L¹ and L² represent each a single bond or a divalent linking group, and n is 0 or 1. It is preferable that n is 0. Namely, n being 0 indicates that two Q's would never be bonded together to form a ring. Although the divalent linking group is not particularly restricted) a linking group comprising a carbon atom, a nitrogen atom, an oxygen atom, a sulfur atom and a silicon atom are preferred. Next, specific examples of the divalent linking group will be presented, though the invention is not restricted thereto.

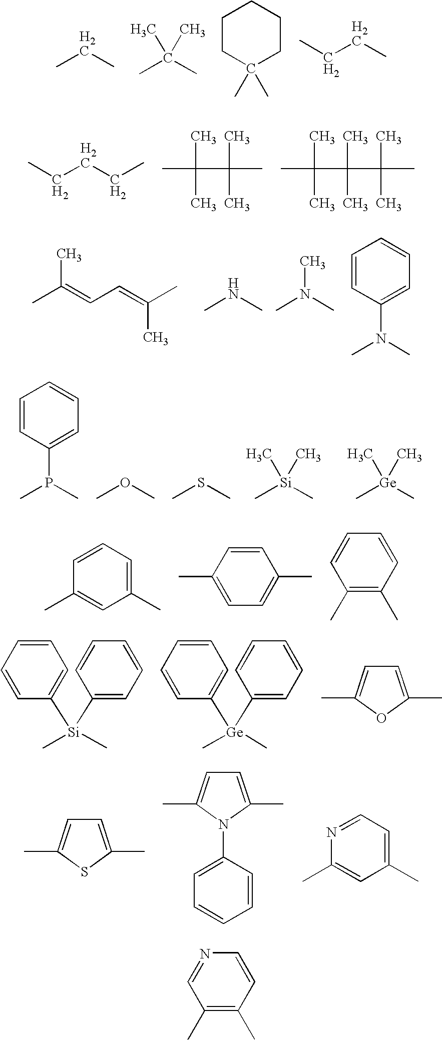

These linking groups may have a substituent. As examples of the substituents which can be introduced, those cited above as substituents for Z¹ and Z² can be enumerated.

As L¹, a dialkylmethylene group, a diarylmethylene group and a diheteroarylmethylene group are preferred, a dimethylmethylene group and a diphenylmethylene group are still preferred and a dimethylmethylene group is still preferred.

Among the complexes represented by the formula (I), one represented by the formula (II) may be cited as one of preferred embodiments. In the formula (II), Z¹, Z² and L¹ each have the same meanings as defined in the formula (I) and preferred ranges are also the same. R²¹s and R²²s each independently represent a hydrogen atom or a substituent. The substituents have the same meaning as the substituent group A. R²¹ and R²² attached to the same pyrazole ring may be bonded together to form a fused ring. An R²² may be bonded to another R²² attached to a different pyrazole ring to form a ring.

As R²¹, a hydrogen atom, a methyl group) a trifluoromethyl group, a t-butyl group and a cyano group are preferred, a methyl group, a trifluoromethyl group, a t-butyl group and a cyano group are still preferred and a trifluoromethyl group, a t-butyl group and a cyano group are still preferred.

As R²², a hydrogen atom, a methyl group, a trifluoromethyl group, a t-butyl group, a cyano group and such a group that R²²s are bonded together to form substituted or unsubstituted methylene or ethylene are preferred. A hydrogen atom, a cyano group and such a group that R²²s are bonded together to form substituted or unsubstituted ethylene are still preferred and hydrogen atom and such a group that R²²s are bonded together to form tetramethylethylene are still preferred.

Among the complexes represented by the formula (I), one represented by the formula (III) may be cited as another preferred embodiment. In the formula (III), Z¹, Z² and L¹ each have the same meanings as defined in the formula (I) and preferred ranges are also the same. R³¹s, R³²s and R³³s each independently represent a hydrogen atom or a substituent. The substituents have the same meaning as the substituent group A. R³¹, R³² and R³³ may be bonded together to form a fused ring.

As the fused ring formed by R³¹, R³² and R³³ bonded together, there can be enumerated a benzene ring, a pyridine ring, a pyrazine ring, a pyrimidine ring, a pyridazine ring, a pyrrole ring, a pyrazole ring, an imidazole ring, an oxazole ring, a thiazole ring, an isothiazole ring, an isooxazole ring and so on and a benzene ring, a pyridine ring, a pyrimidine ring and a pyrazine ring are preferred. Further, another ring may be fused to such a ring.

As R³¹, a hydrogen atom, an alkyl group, an aryl group, a cyano group and such a group as forming a fused ring together with R³² are preferred, a hydrogen atom, a methyl group, a t-butyl group, a phenyl group, a cyano group, a trifluoromethyl group and such a group as forming a fused ring together with R³² are still preferred, and a methyl group, a t-butyl group and such a group as forming a fused ring together with R³² are still preferred.

As R³², a hydrogen atom, an alkyl group, an aryl group, a cyano group, such a group as forming a fused ring together with R³¹ and such a group as forming a fused ring together with R³³ are preferred, a hydrogen atom, a methyl group, a t-butyl group, a phenyl group, a cyano group, a trifluoromethyl group, such a group as forming a fused ring together with R³¹ and such a group as forming a fused ring together with R³³ are still preferred, and a t-butyl group, a cyano group, a trifluoromethyl group and such a group as forming a fused ring together with R³¹ are still preferred.

As R³³, a hydrogen atom, an alkyl group, an aryl group, a cyano group and such a group as forming a fused ring together with R³² are preferred, a hydrogen atom, a methyl group and such a group as forming a fused ring together with R³² are still preferred, and a hydrogen atom and such a group as forming a fused ring together with R³² are still preferred.

Among the complexes represented by the formula (I), one represented by the formula (IV) may be cited as still another preferred embodiment. In the formula (IV), Z¹, Z² and L¹ each have the same meanings as defined in the formula (I) and preferred ranges are also the same. R⁴¹s and R⁴²s each independently represent a hydrogen atom or a substituent. As the substituents, those selected from the substituent group A can be enumerated. R⁴¹ and R⁴² may be bonded together to form a fused ring. As the fused ring formed by R⁴¹ and R⁴² bonded together, there can be enumerated a benzene ring, a pyridine ring, a pyrazine ring, a pyrimidine ring, a pyridazine ring, a pyrrole ring, a pyrazole ring, an imidazole ring, an oxazole ring, a thiazole ring, an isothiazole ring, an isooxazole ring and so on and a benzene ring, a pyridine ring, a pyrimidine ring and a pyrazine ring are preferred. Further, another ring may be fused to such a ring.

As R⁴¹, a hydrogen atom, an alkyl group, an aryl group, a cyano group and such a group as forming a fused ring together with R⁴² are preferred, a hydrogen atom, a methyl group, a t-butyl group, a phenyl group, a cyano group, a trifluoromethyl group and such a group as forming a fused ring together with R⁴² are still preferred, and a methyl group, a cyano group and such a group as forming a fused ring together with R⁴² are still preferred.

As R⁴², a hydrogen atom, an alkyl group, an aryl group, a cyano group and such a group as forming a fused ring together with R⁴¹ are preferred, a hydrogen atom, a methyl group, a t-butyl group, a phenyl group, a cyano group, a trifluoromethyl group and such a group as forming a fused ring together with R⁴¹ are still preferred, and methyl group, a cyano group and such a group as forming a fused ring together with R⁴¹ are still preferred.

As the complex represented by the formula (II), a complex represented by the formula (IIA) is still preferred.

Next, the formula (IIA) will be illustrated. L¹ has the same meaning as defined in the formula (I) and the preferred range is also the same. R²¹s, R²²s, R⁵¹, R⁵², R⁵³, R⁵⁴, R⁵⁵ and R⁵⁶ each independently represent a hydrogen atom or a substituent. R²¹s and R²²s have the same meanings as defined in the formula (II) and the preferred ranges are also the same. The substituents represented by R⁵¹ to R⁵⁶ have the same meanings as the substituent group A. If possible, R⁵¹ to R⁵⁶ may be bonded together to form a ring.

As R⁵¹, R⁵³, R⁵⁴ and R⁵⁶ as described above, a hydrogen atom, an alkyl group, an aryl group, an amino group, an alkoxy group, an aryloxy group, an acyl group; an alkoxycarbonyl group, an alkylthio group, a sulfonyl group, a hydroxy group, a halogen atom, a cyano group, a nitro group and a heterocyclic group are preferred, a hydrogen atom, an alkyl group, an aryl group, a halogen atom, a cyano group and a heterocyclic group are still preferred, a hydrogen atom, a methyl group, a t-butyl group, a trifluoromethyl group, a phenyl group, a fluorine atom, a cyano group and a pyridyl group are still preferred, and a hydrogen atom, a methyl group and a fluorine atom are still preferred. A hydrogen atom is particularly preferred therefor.

As R⁵² and R⁵⁵ as described above, a hydrogen atom, an alkyl group, an aryl group, an amino group, an alkoxy group, an aryloxy group, an alkylthio group, an arylthio group, a halogen atom, a cyano group and a heterocyclic group are preferred, a hydrogen atom, an alkyl group, an aryl group, an amino group, an alkoxy group, an aryloxy group and a heterocyclic group are still preferred, a hydrogen atom, an alkyl group, an amino group, an alkoxy group and a heterocyclic group are still preferred, and a hydrogen atom, a methyl group, a t-butyl group, a dimethylamino group, a diphenylamino group, a methoxy group and a carbazolyl group are still preferred. A hydrogen atom is particularly preferred therefor.

As the complex represented by the formula (IIA), a complex represented by the formula (IIB) is still preferred. Next, the formula (IIB) will be illustrated. In the formula (IIB), R²¹s, R²²s, R⁵¹, R⁵², R⁵³, R⁵⁴, R⁵⁵, R⁵⁶, R⁶¹ and R⁶² each independently represent a hydrogen atom or a substituent. R²¹s and R²²s have the same meanings as defined in the formula (II) and the preferred ranges are also the same. R⁵¹ to R⁵⁶ have the same meanings as defined in the formula (IIA) and the preferred ranges are also the same. R⁶¹ and R⁶² represent each a hydrogen atom or a substituent. The substituents represented by R⁶¹ and R⁶² have the same meanings as the substituent group A. As R⁶¹ and R⁶², a hydrogen atom, an alkyl group, an aryl group, a halogen atom, a cyano group and a heterocyclic group are preferred, a hydrogen atom, a methyl group, a trifluoromethyl group, a phenyl group, a fluorine atom, a cyano group and a pyridyl group are still preferred, a methyl group, a phenyl group and a pyridyl group are still preferred, and a methyl group is still preferred.

As the complex represented by the formula (IIB), a complex represented by the formula (IIC) is still preferred. Next, the formula (IIC) will be illustrated. In the formula (IIC), R²¹s, R²²s, R⁵¹, R⁵², R⁵³, R⁵⁴, R⁵⁵ and R⁵⁶ each independently represent a hydrogen atom or a substituent. R²¹s and R²²s have the same meanings as defined in the formula (II) and the preferred ranges are also the same. R⁵¹ to R⁵⁶ have the same meanings as defined in the formula (IIA) and the preferred ranges are also the same.

As the complex represented by the formula (IIC), a complex represented by the formula (IID) is still preferred. Next, the formula (IID) will be illustrated. In the formula (IID), R⁵¹, R⁵², R⁵³, R⁵⁴, R⁵⁵ and R⁵⁶ each independently represent a hydrogen atom or a substituent. R⁵¹ to R⁵⁶ have the same meanings as defined in the formula (IIA) and the preferred ranges are also the same. R²¹ represents a substituent. The substituent represented by R²¹ has the same meaning as the substituent group A. As R²¹, an alkyl group, an aryl group, an amino group, an alkoxy group, an aryloxy group, an acyl group, an alkoxycarbonyl group, an alkylthio group, a sulfonyl group, a hydroxy group, a halogen atom, a cyano group, a nitro group and a heterocyclic group are preferred, an alkyl group, an aryl group, a sulfonyl group, a halogen atom, a cyano group and a heterocyclic group are still preferred, an alkyl group, a perfluoroalkyl group, an aryl group, a perfluoroaryl group, a sulfonyl group, a halogen atom, a cyano group and a heterocyclic group are still preferred, a methyl group, a t-butyl group, a trifluoromethyl group, a phenyl group, a tolyl group, a pentafluorophenyl group, a mesyl group, a tosyl group, a fluorine atom, a cyano group and a pyridyl group are still preferred, a methyl group, a t-butyl group, a trifluoromethyl group and a cyano group are still preferred, and a t-butyl group, a trifluoromethyl group and a cyano group are particularly preferred.

In the formula (IID), it is preferable R⁵¹, R⁵³, R⁵⁴ and R⁵⁶ are respectively hydrogen atoms.

Next, specific examples of the complex represented by the formula (I) will be presented, though the invention is not restricted thereto.

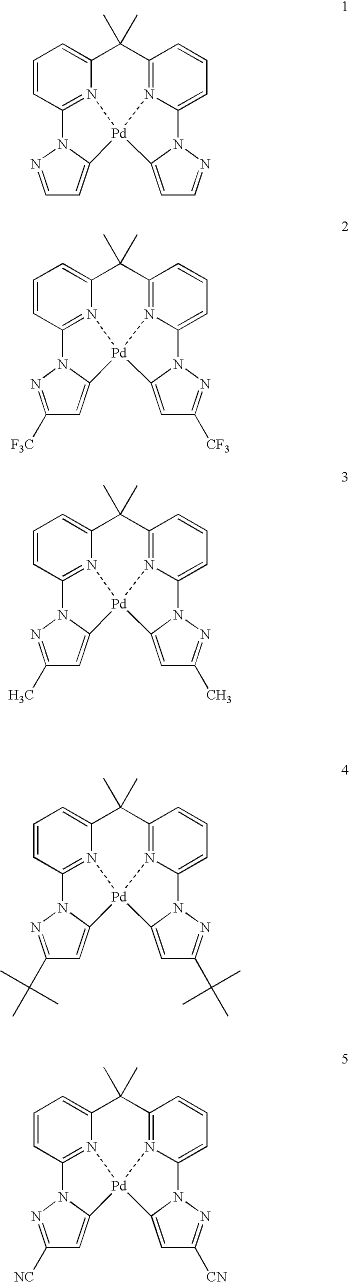

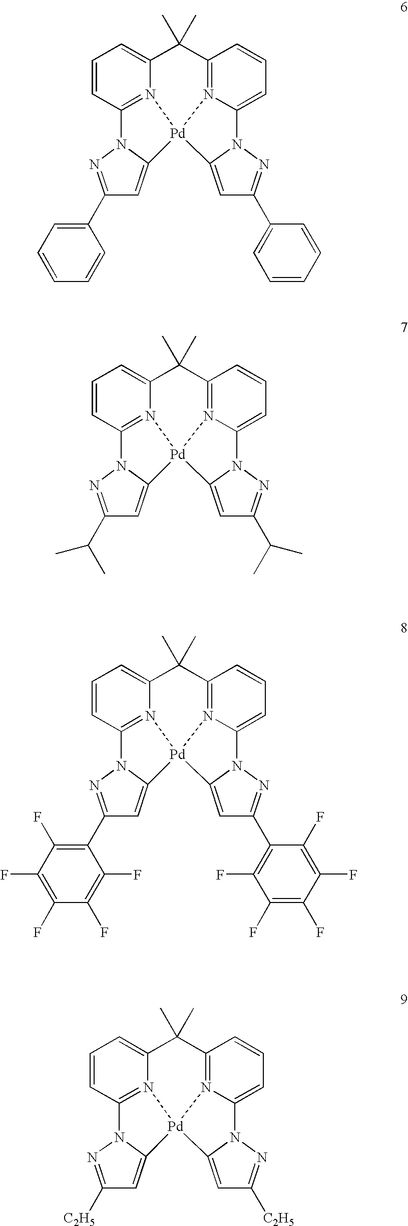

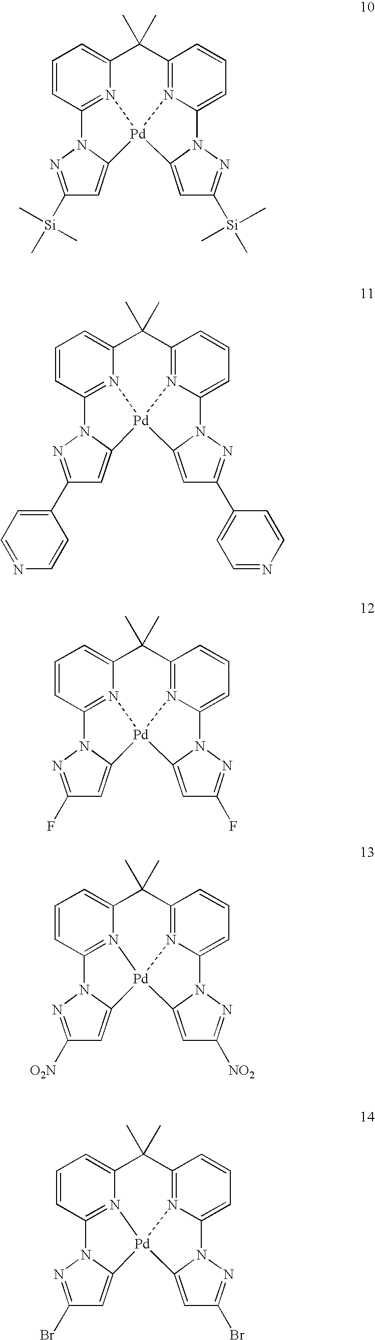

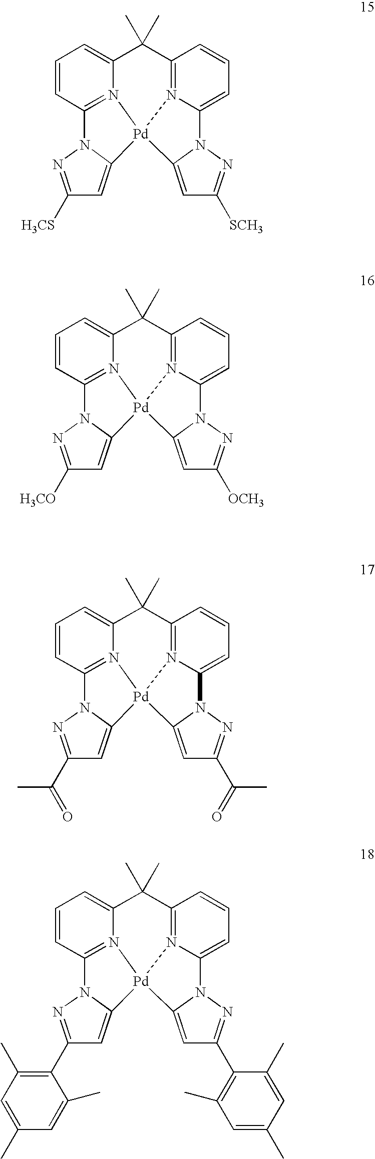

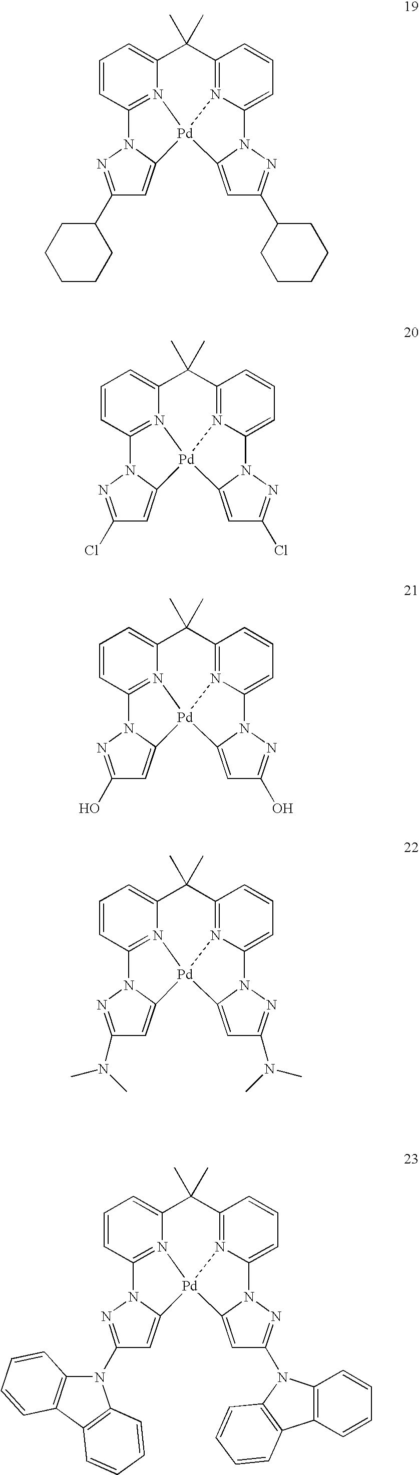

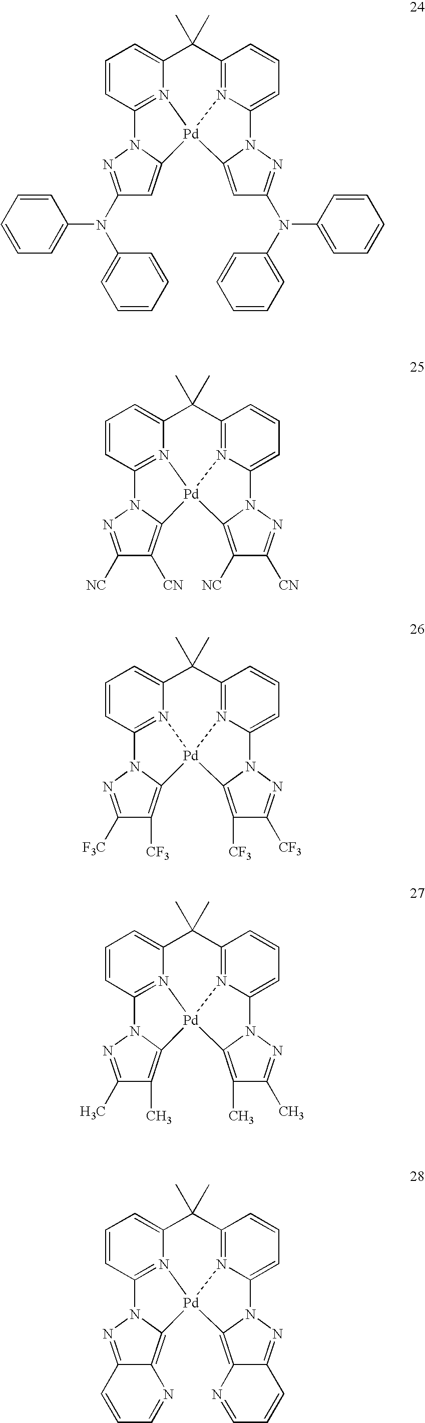

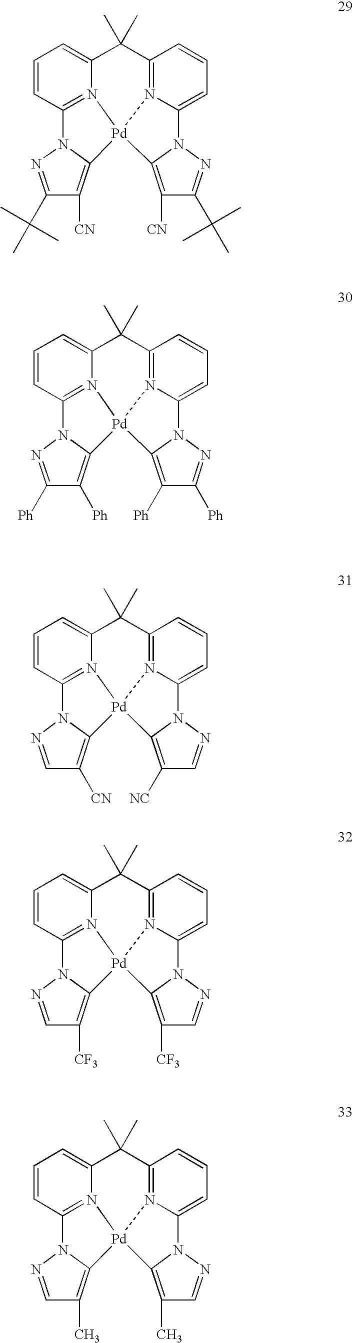

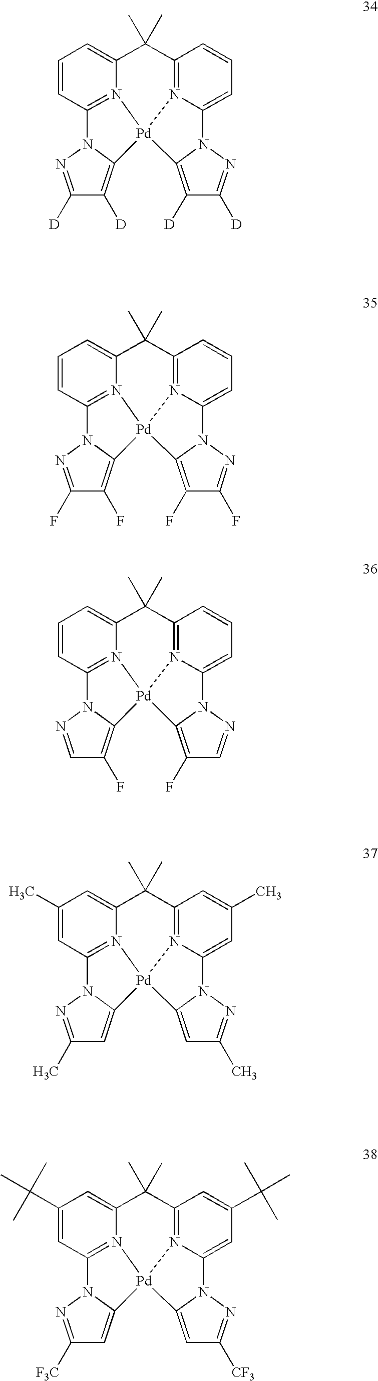

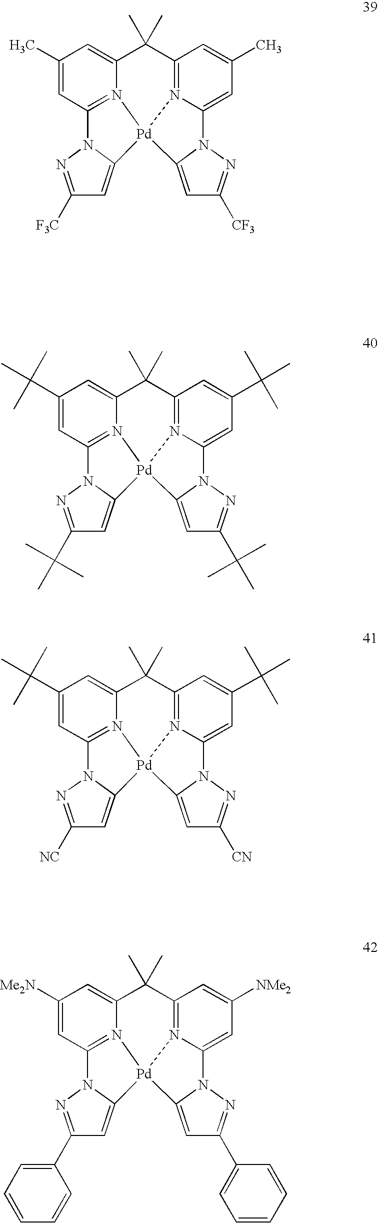

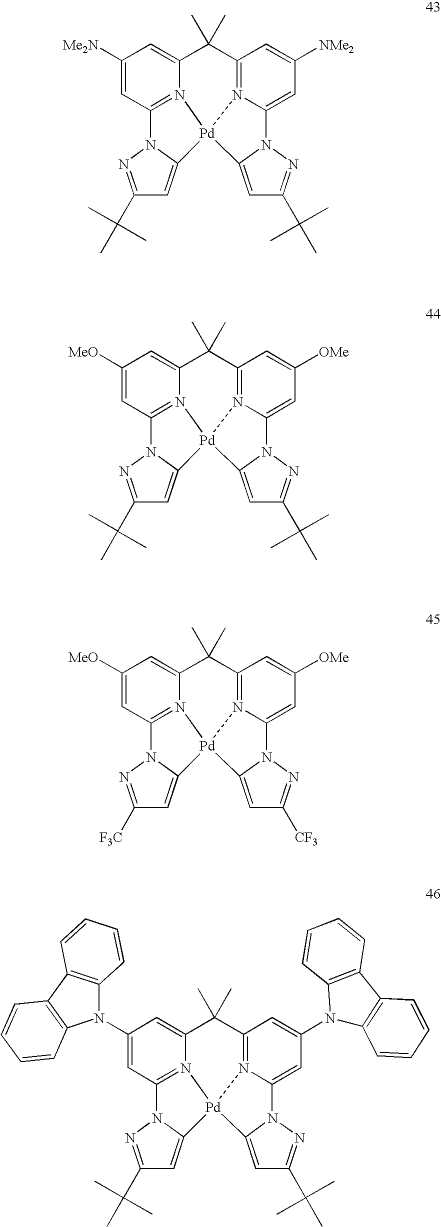

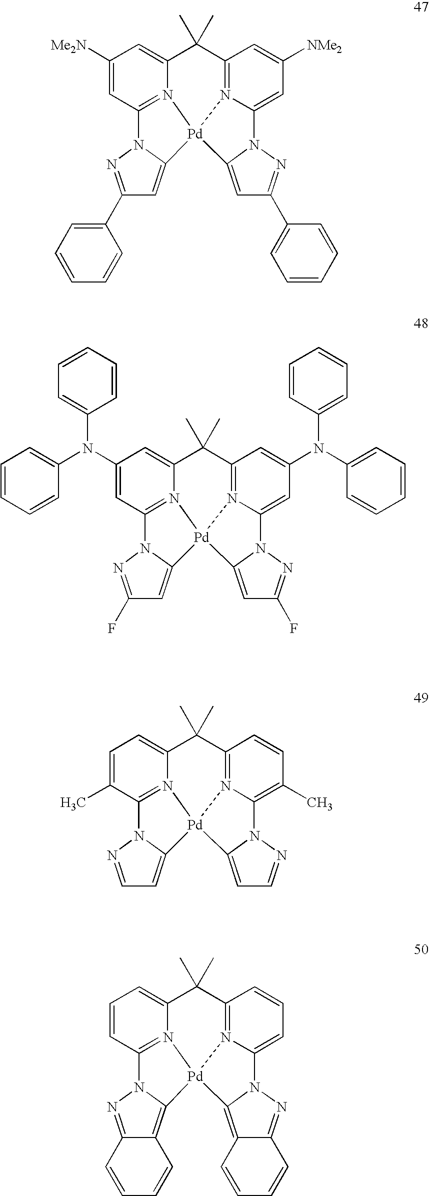

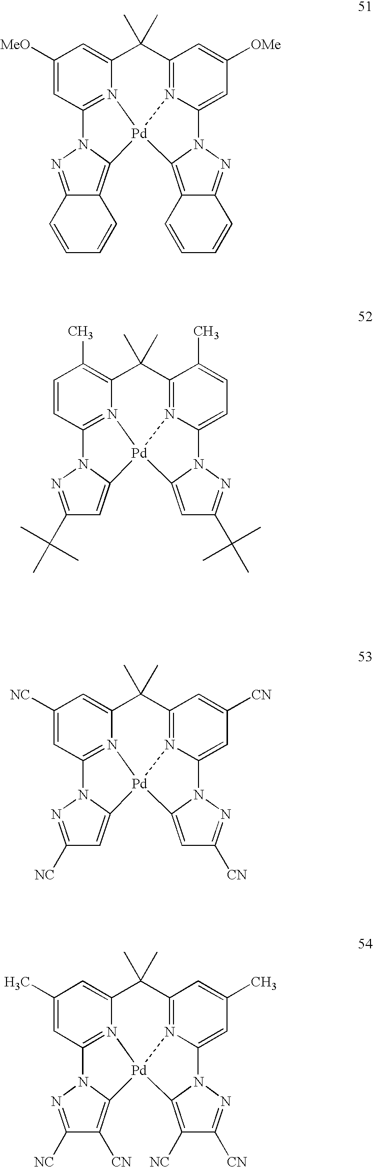

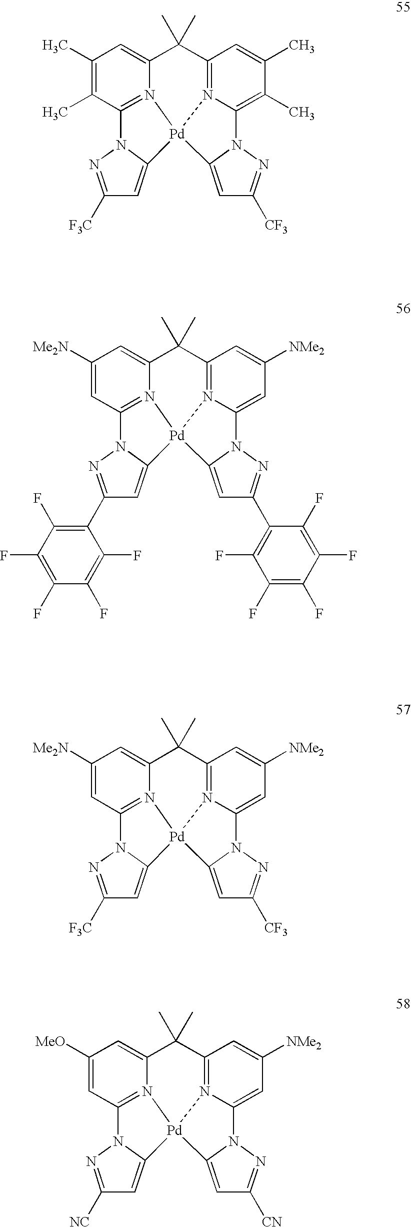

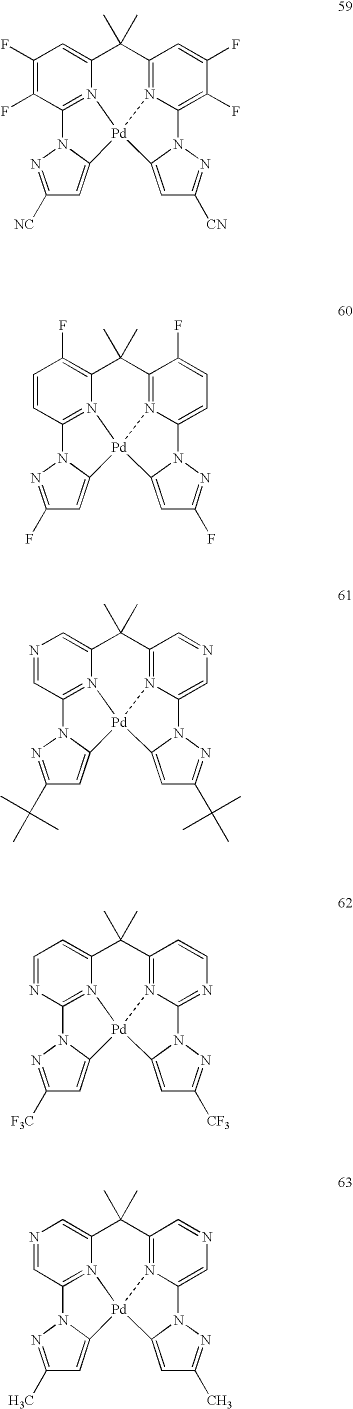

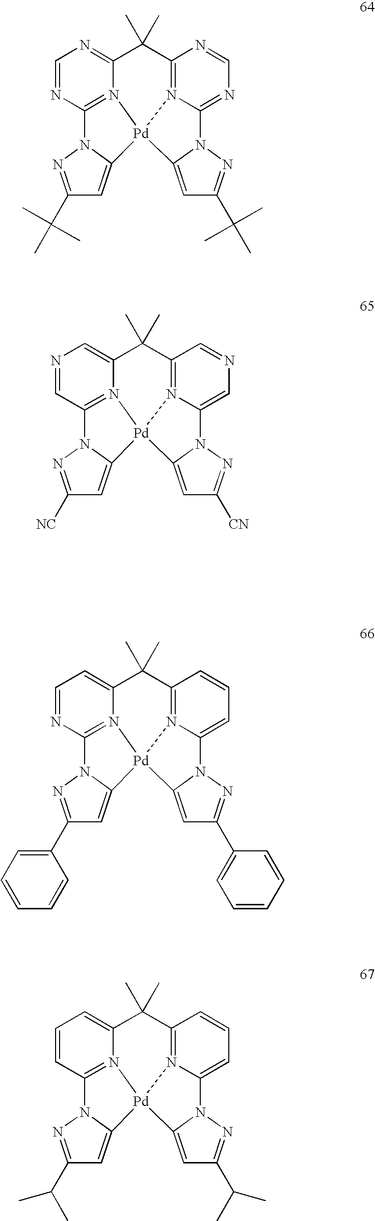

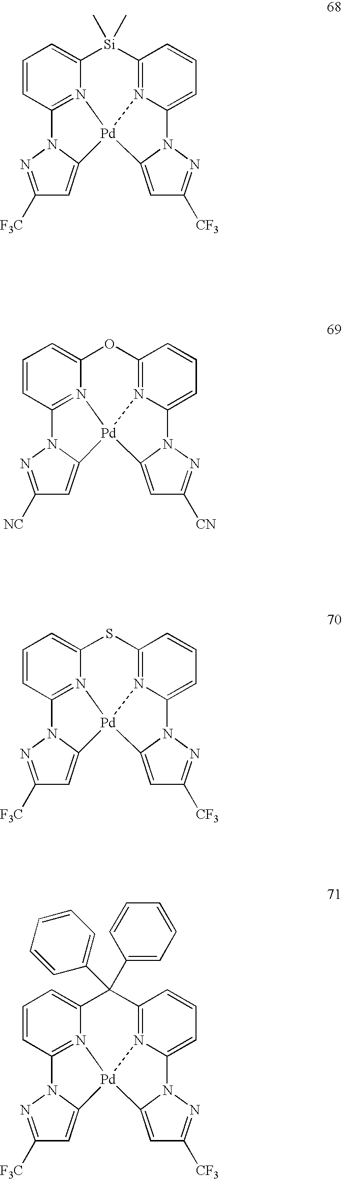

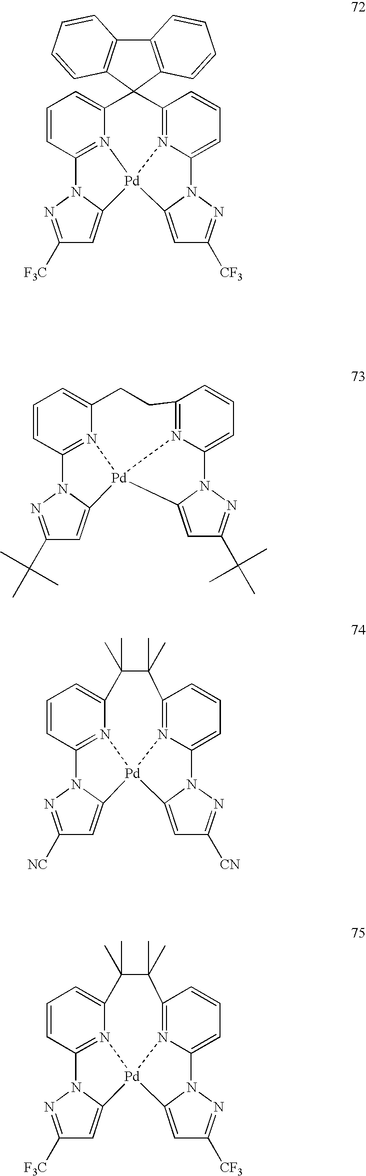

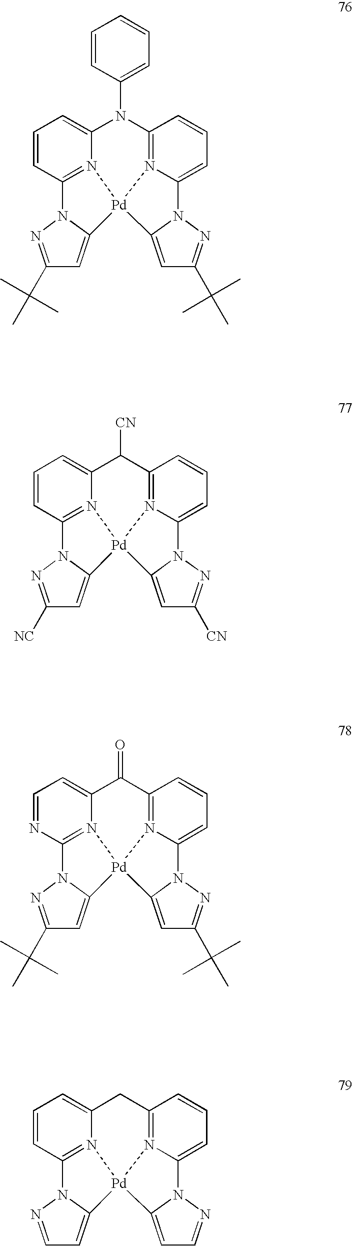

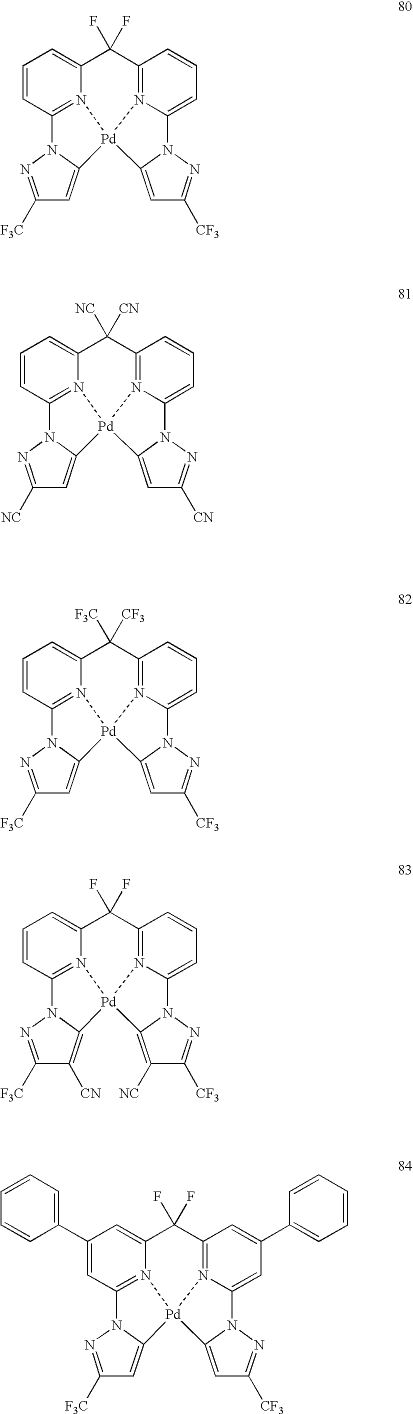

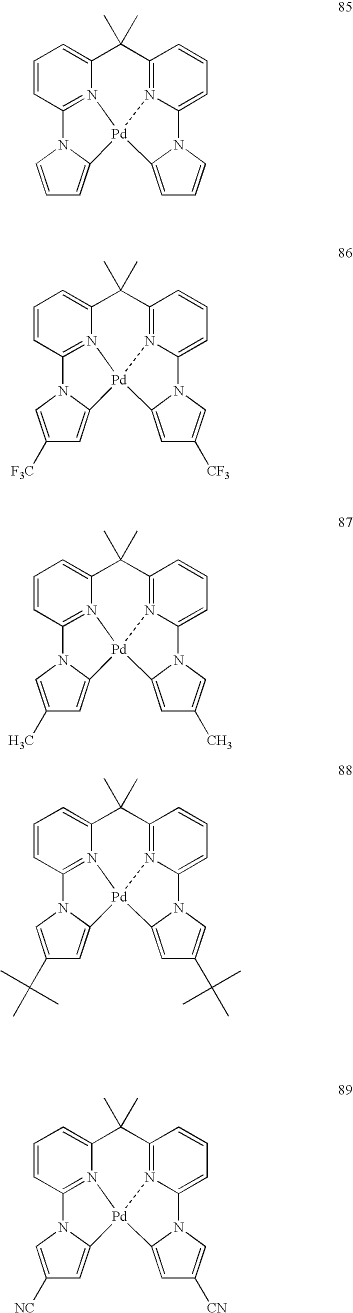

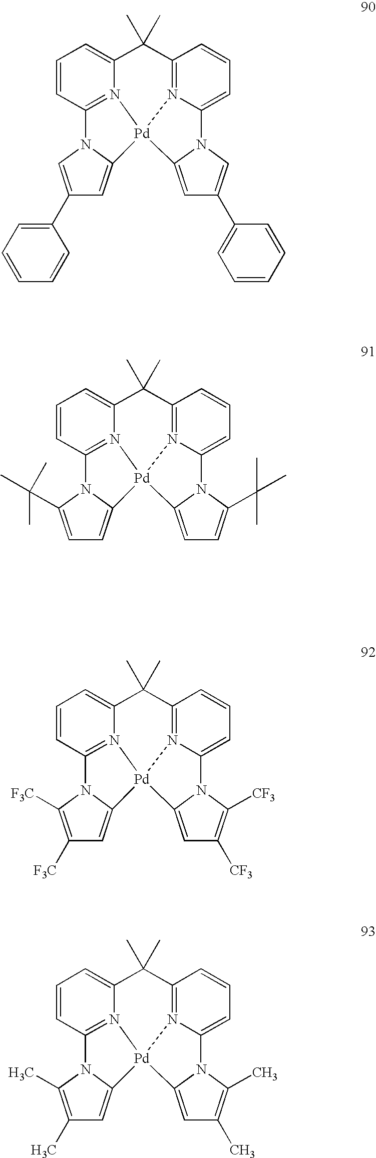

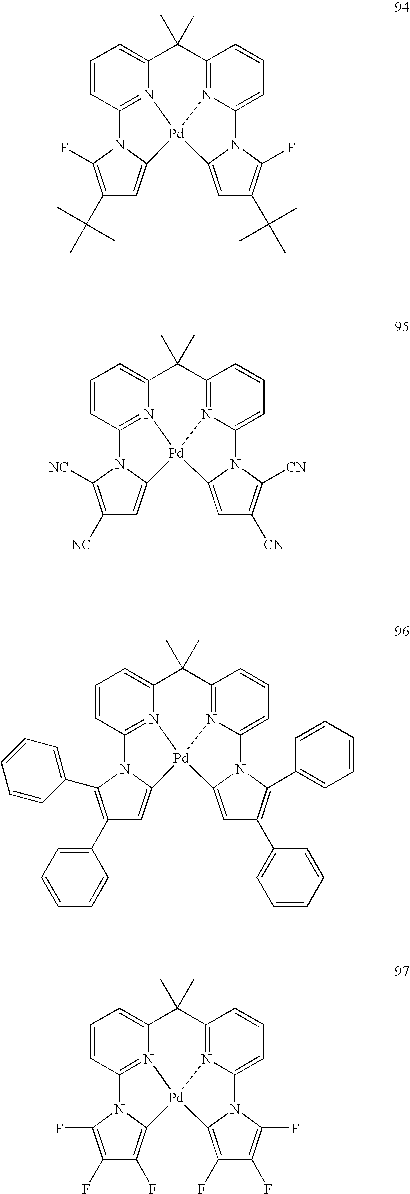

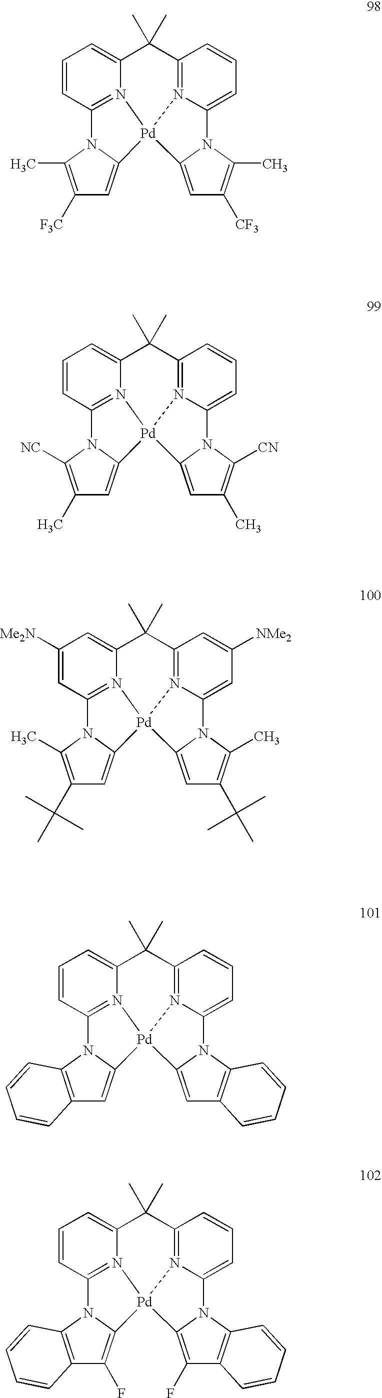

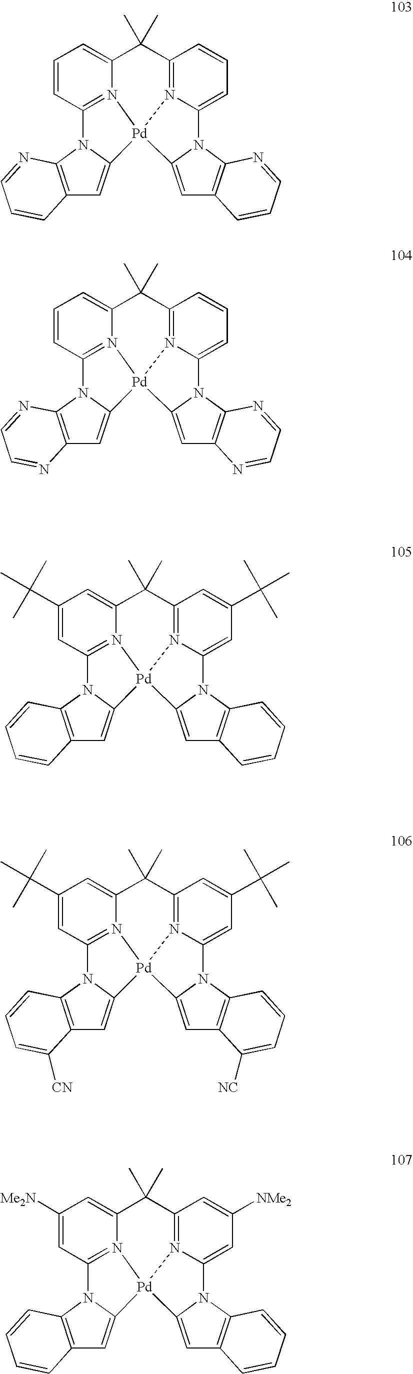

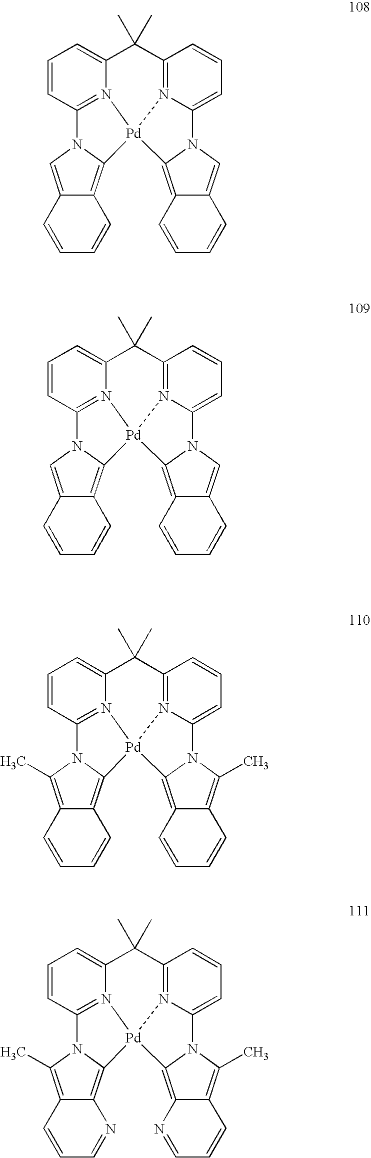

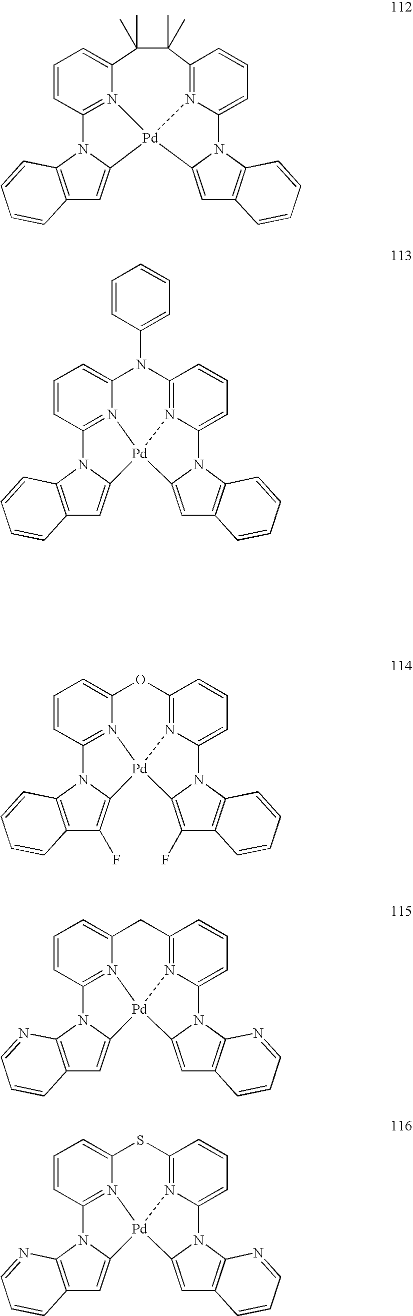

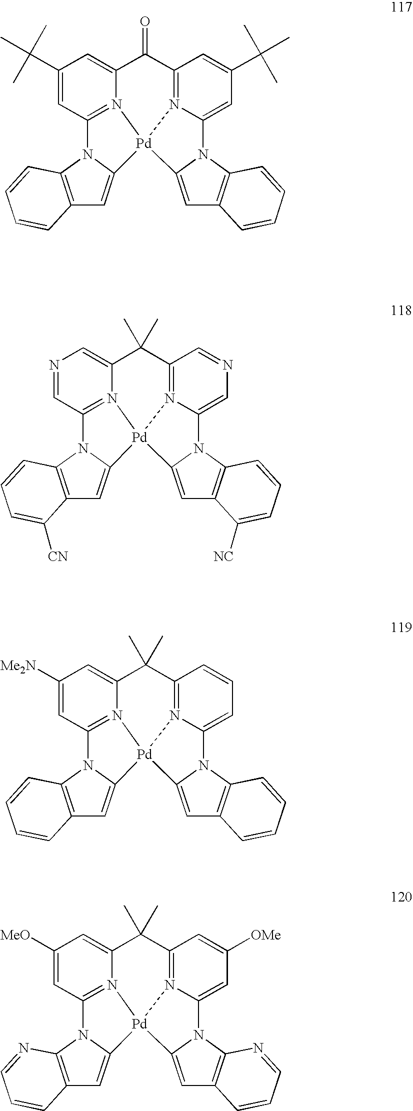

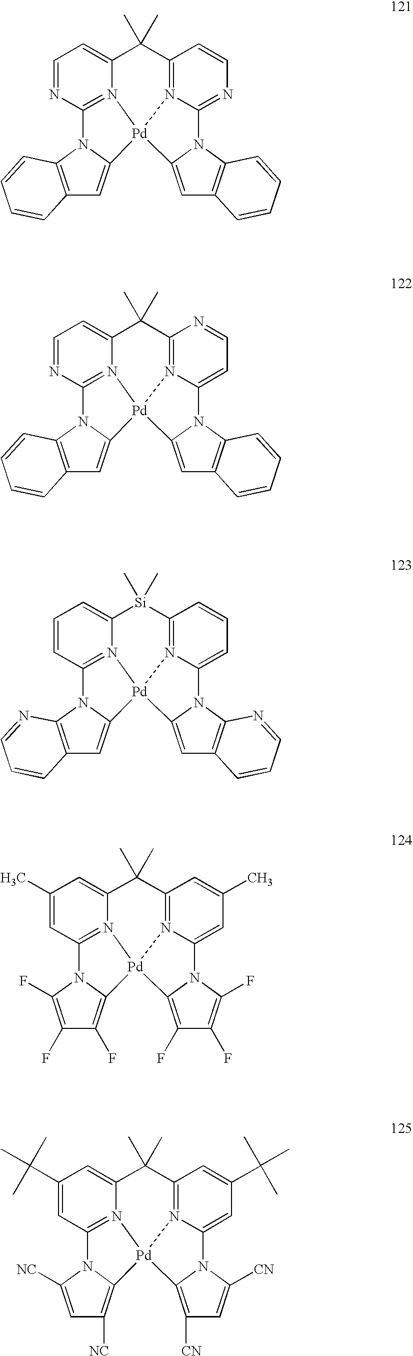

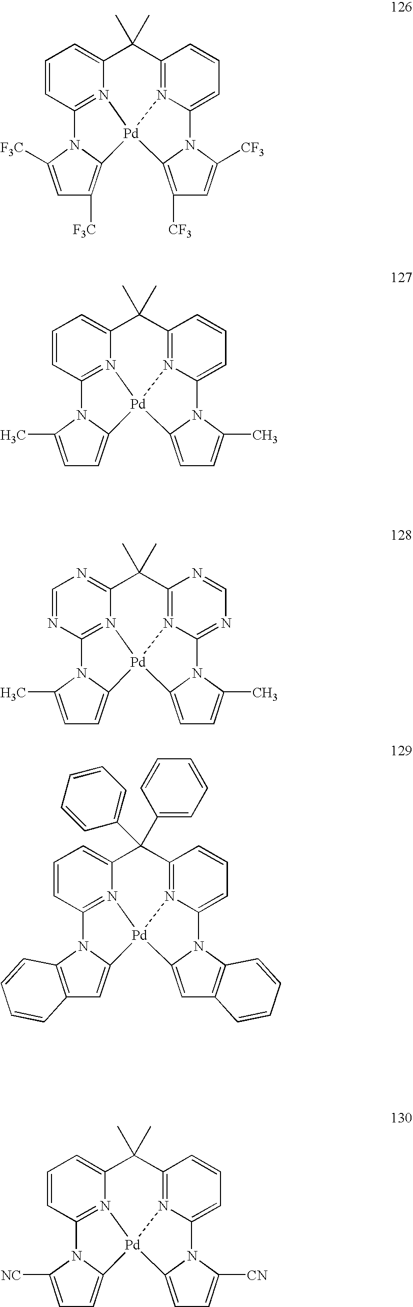

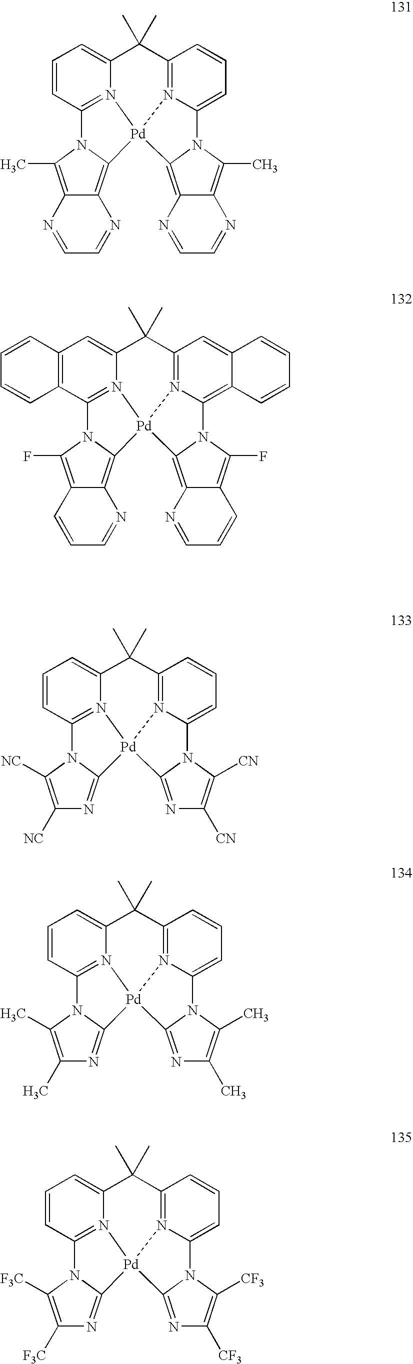

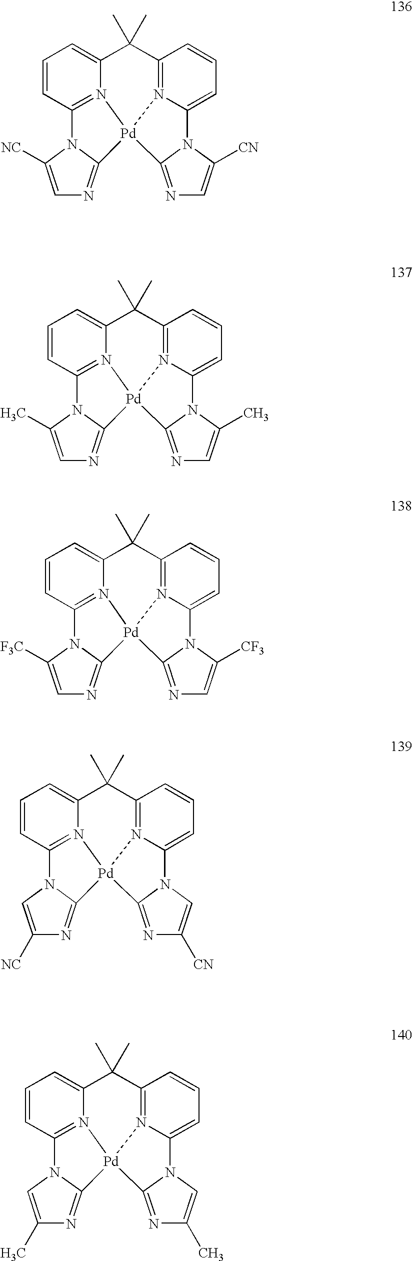

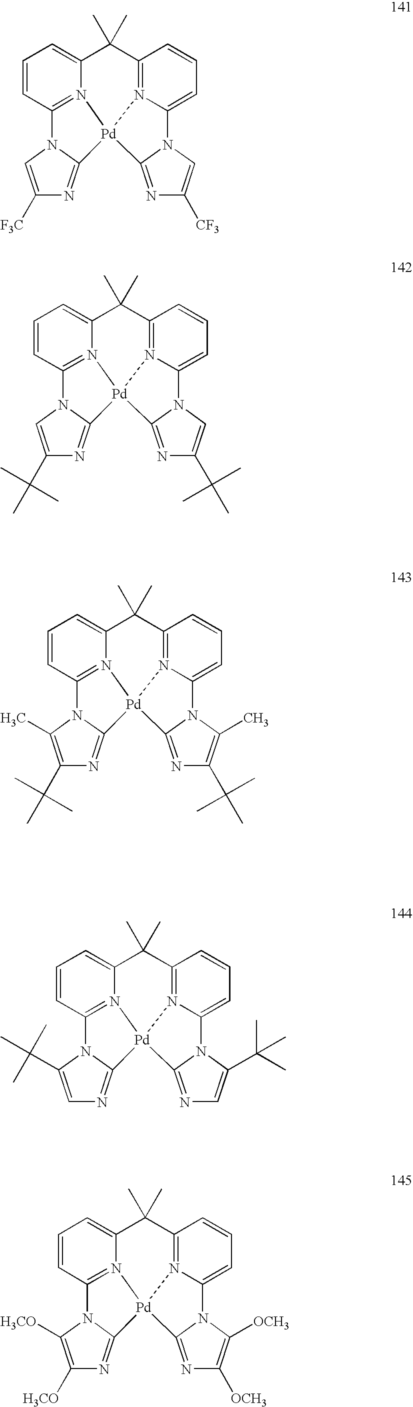

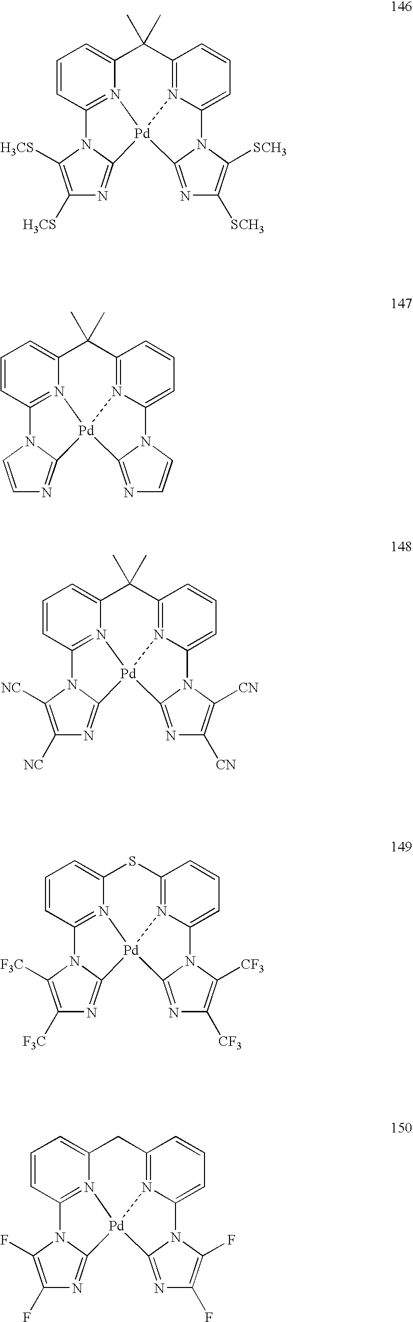

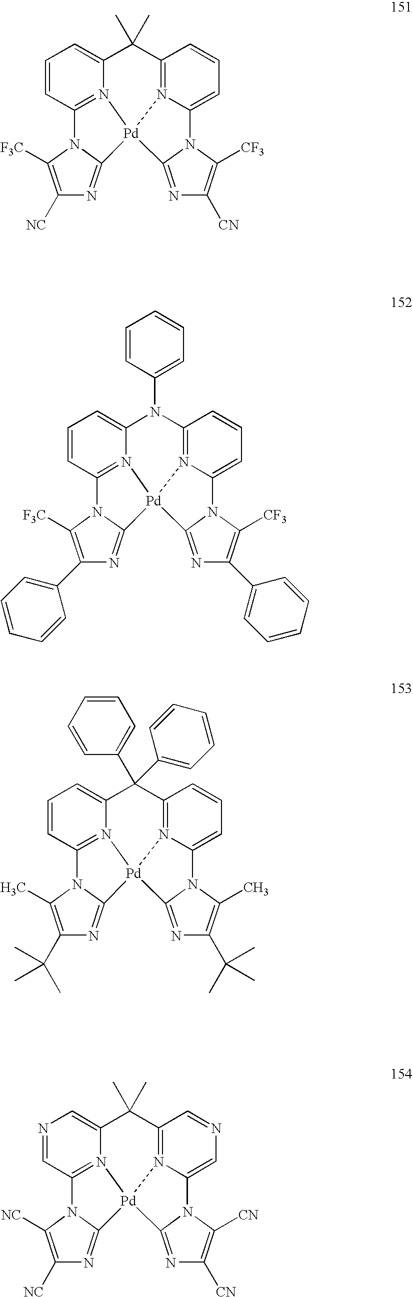

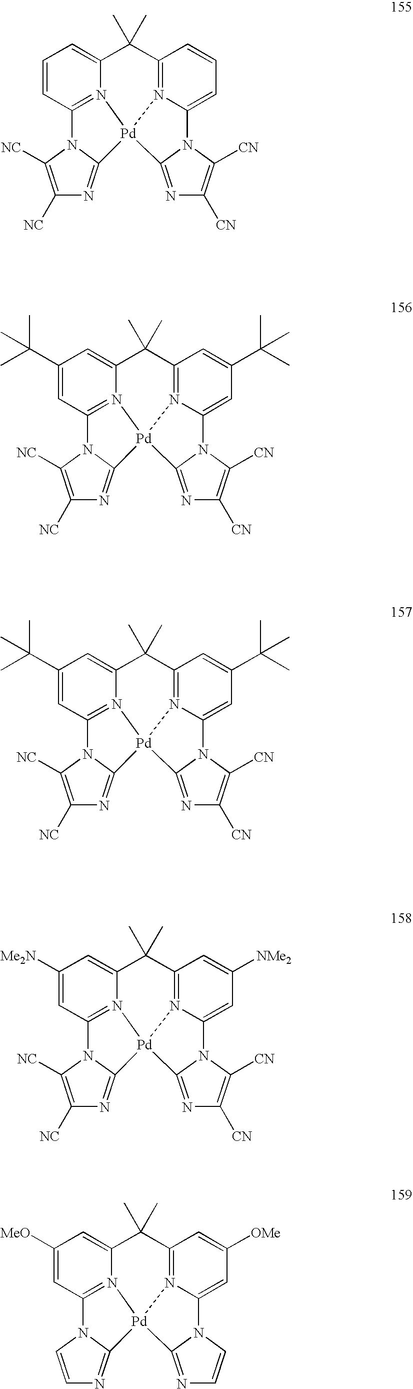

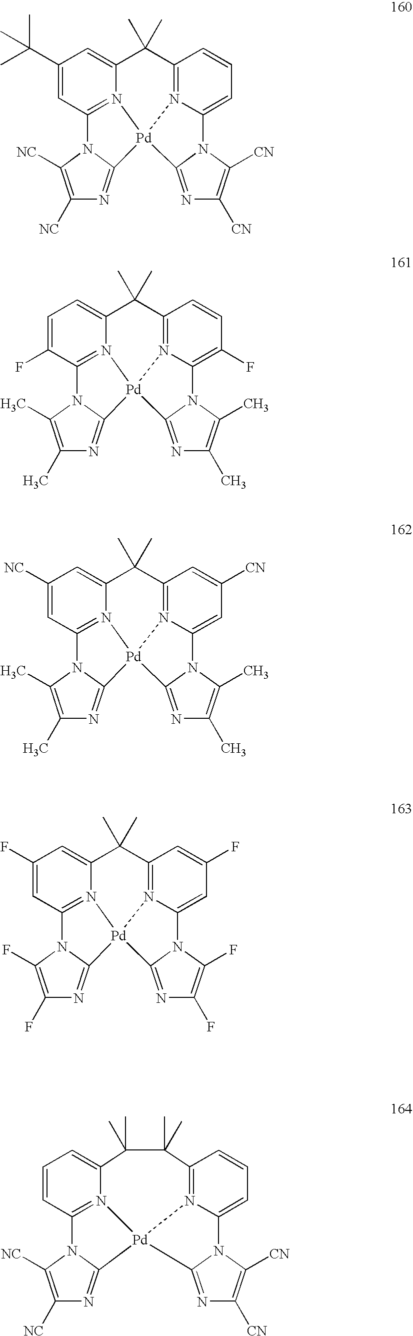

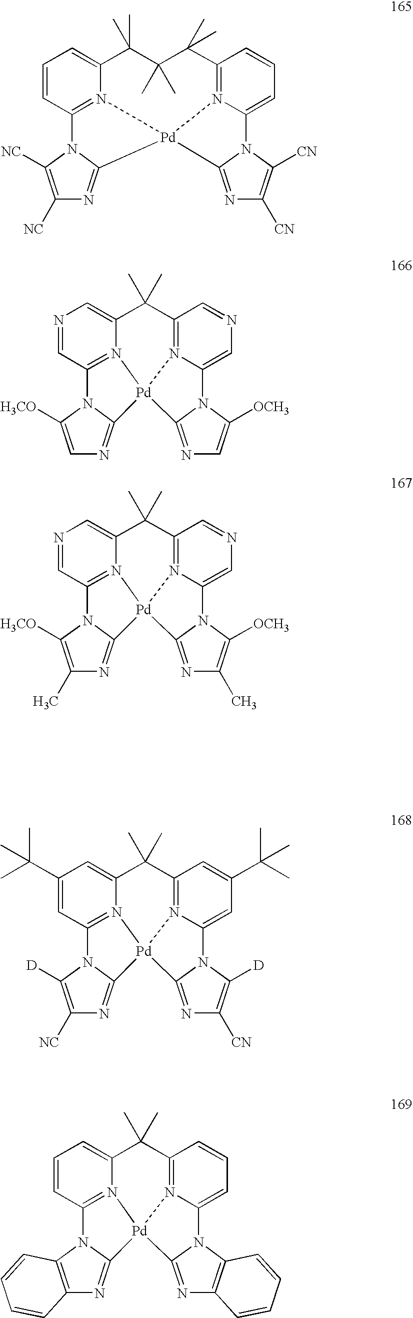

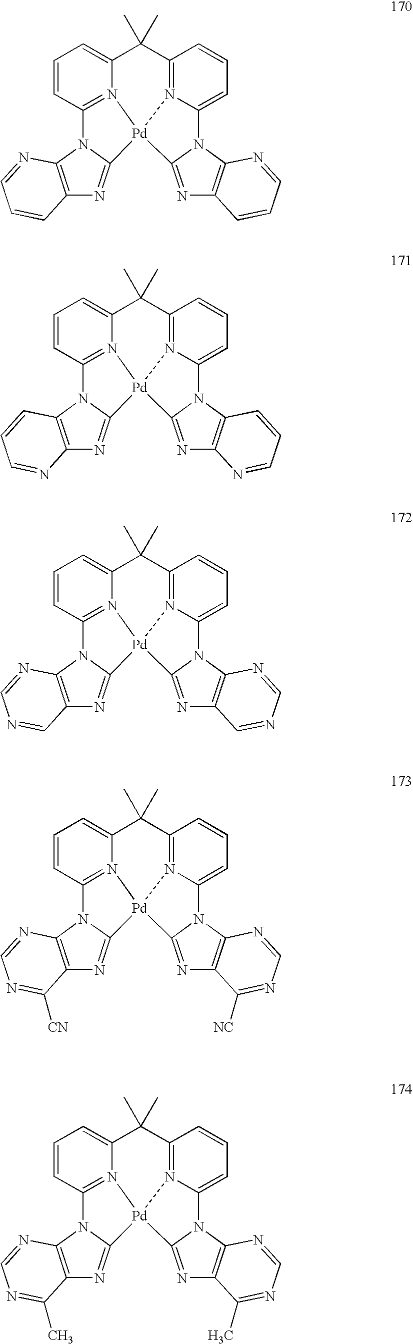

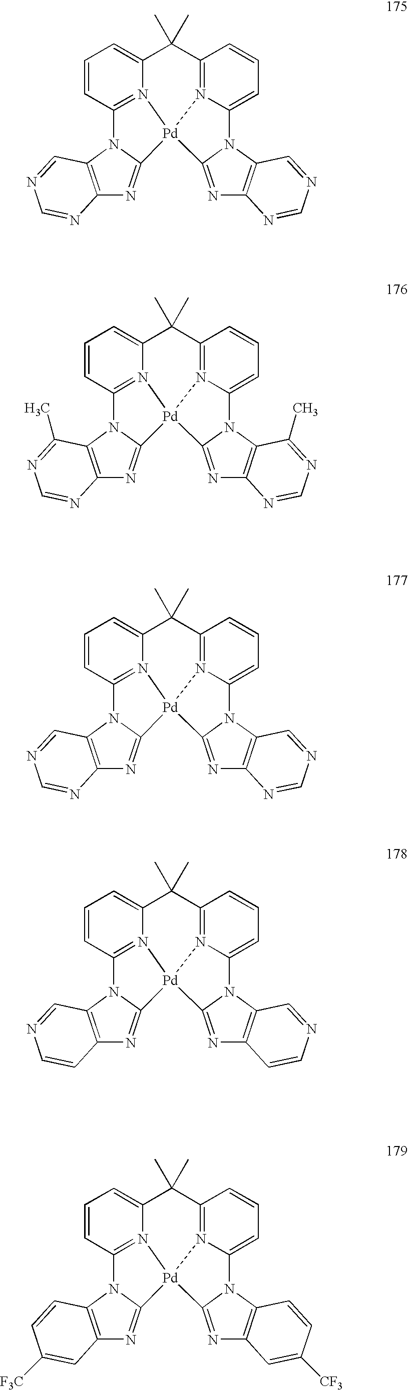

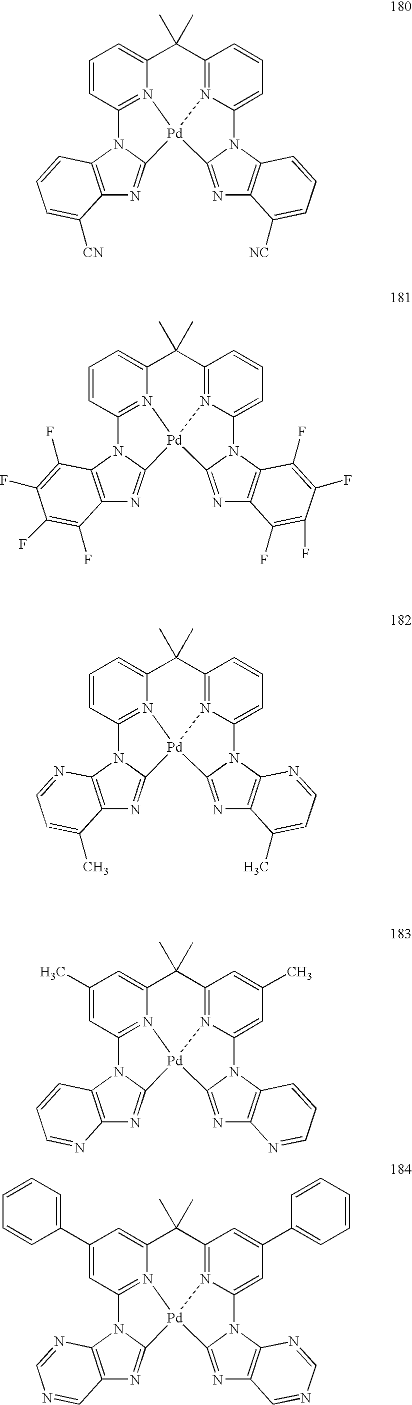

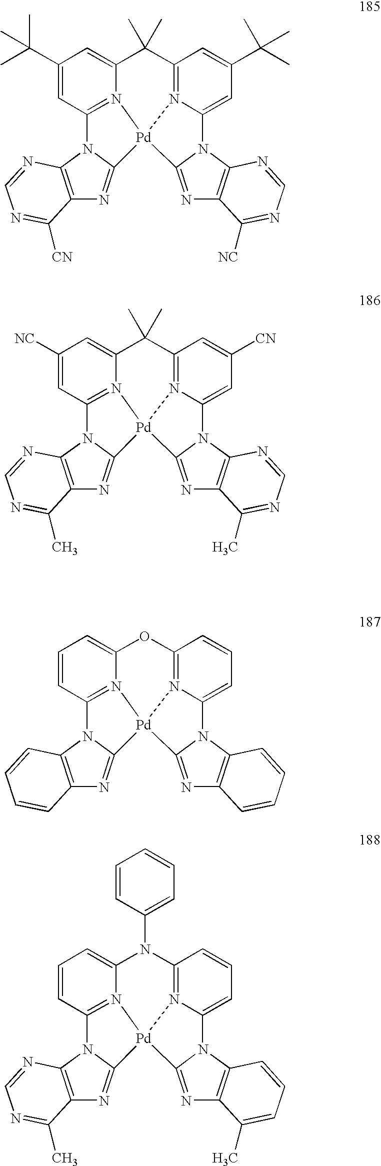

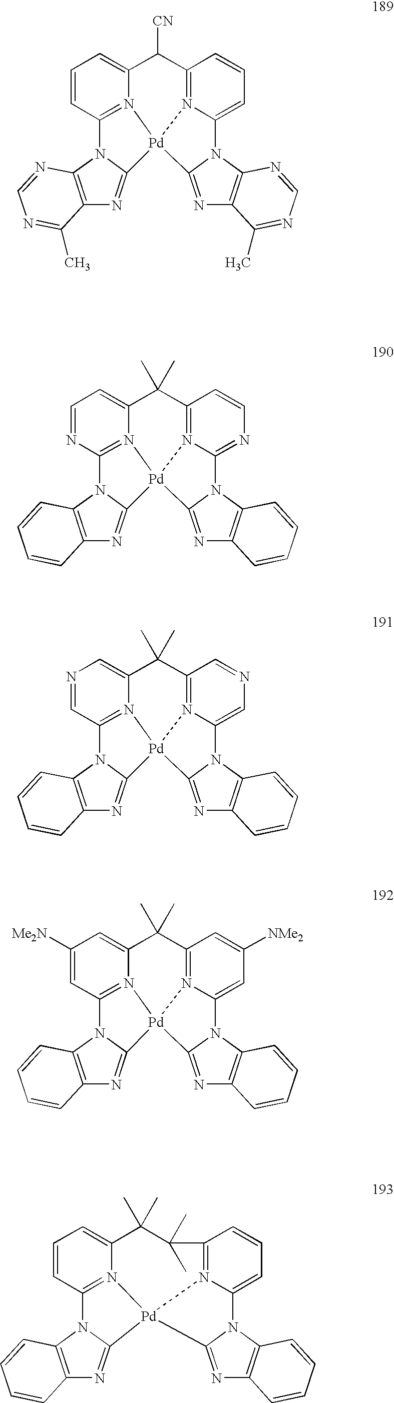

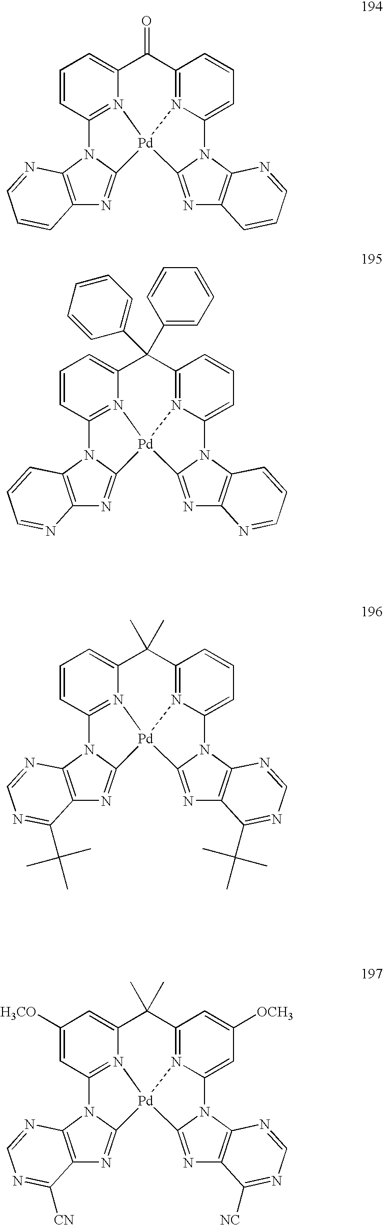

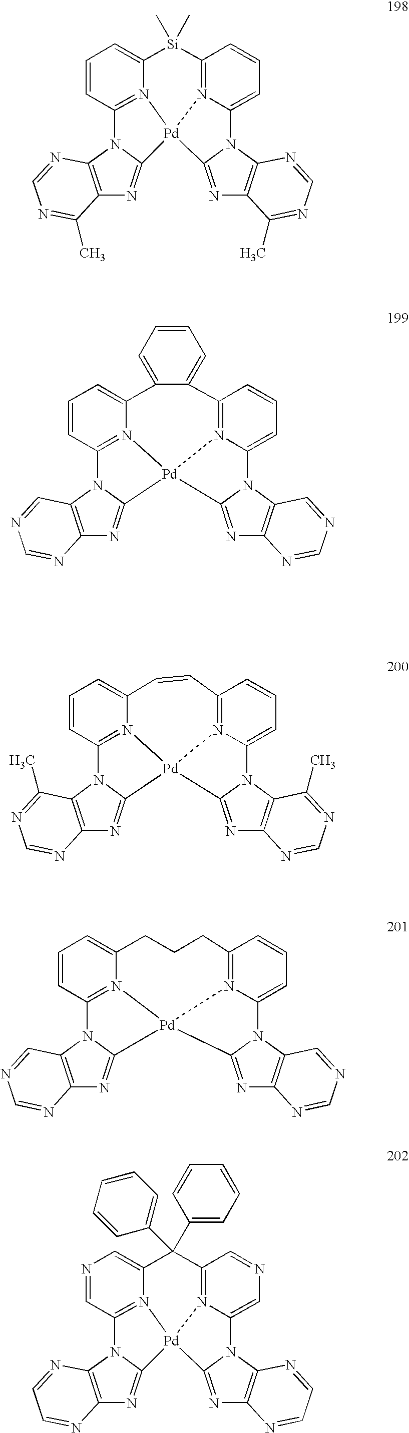

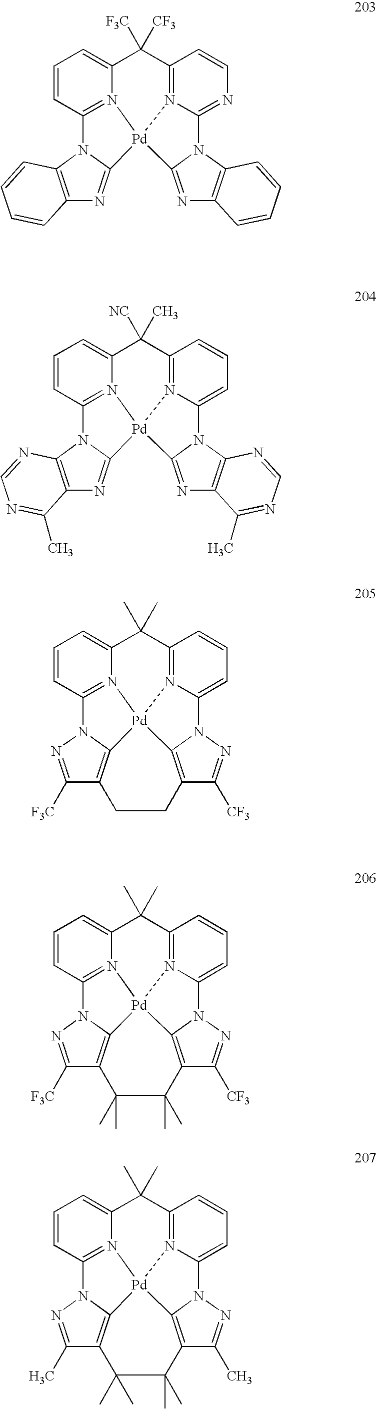

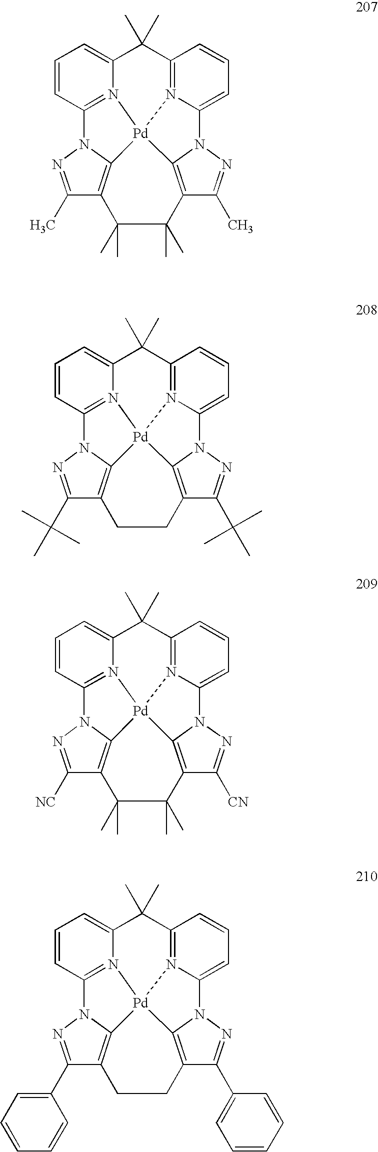

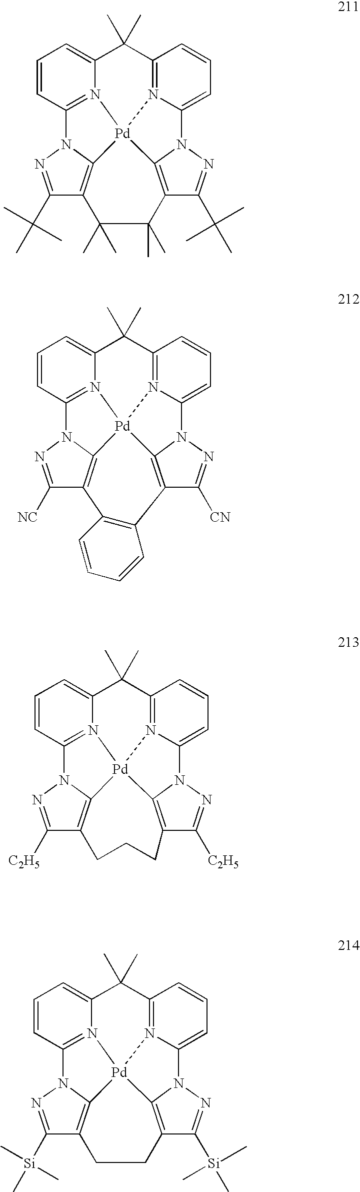

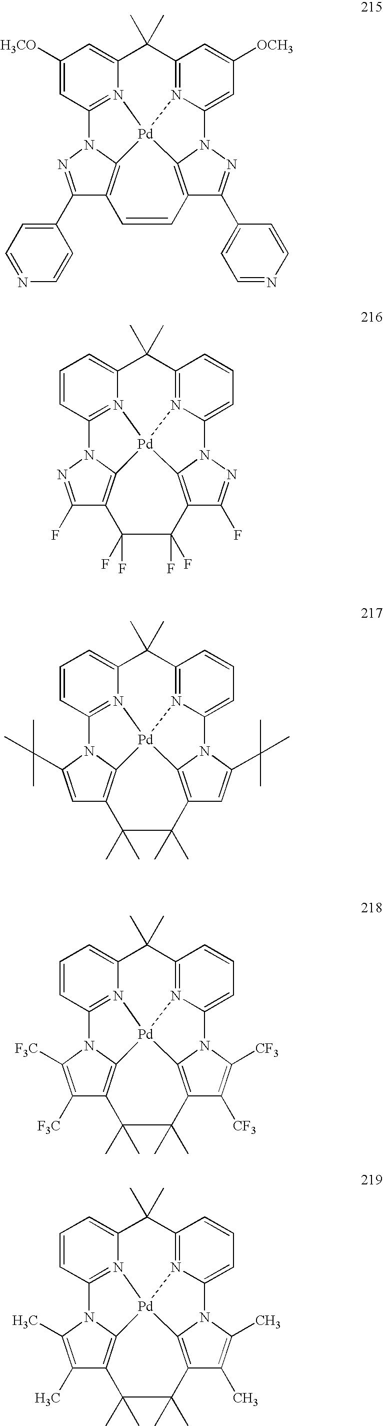

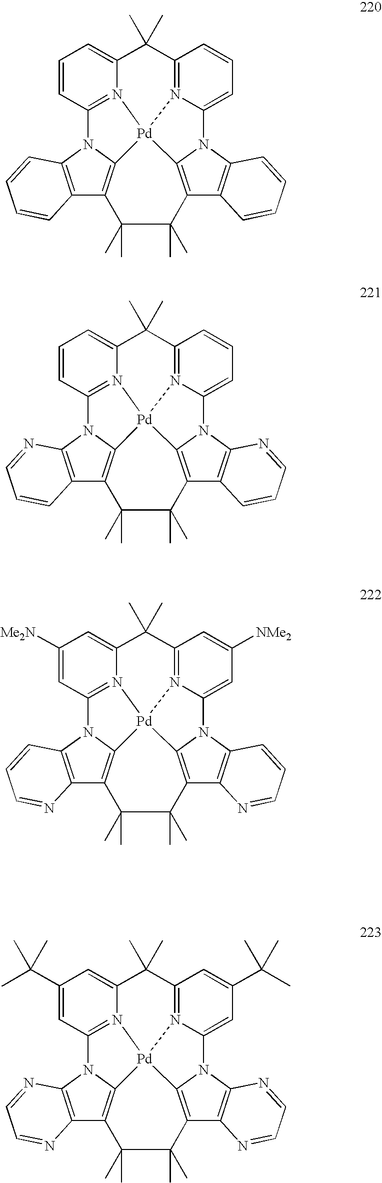

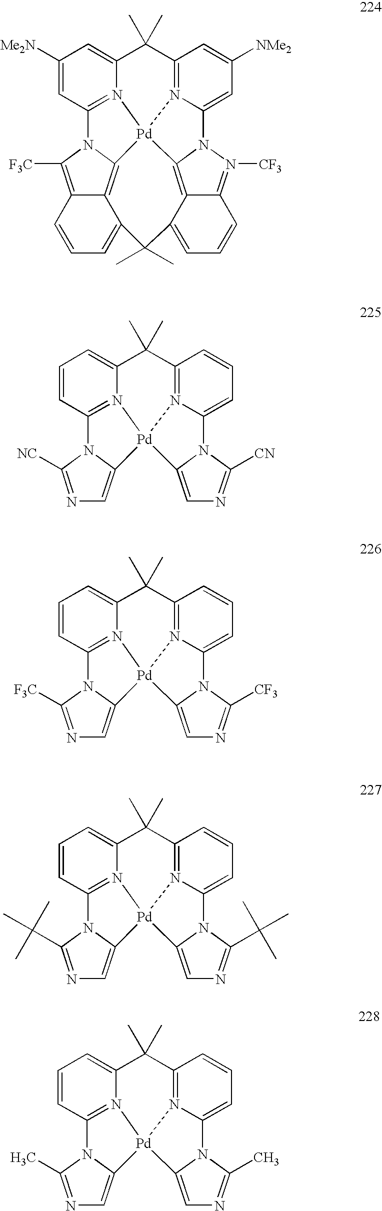

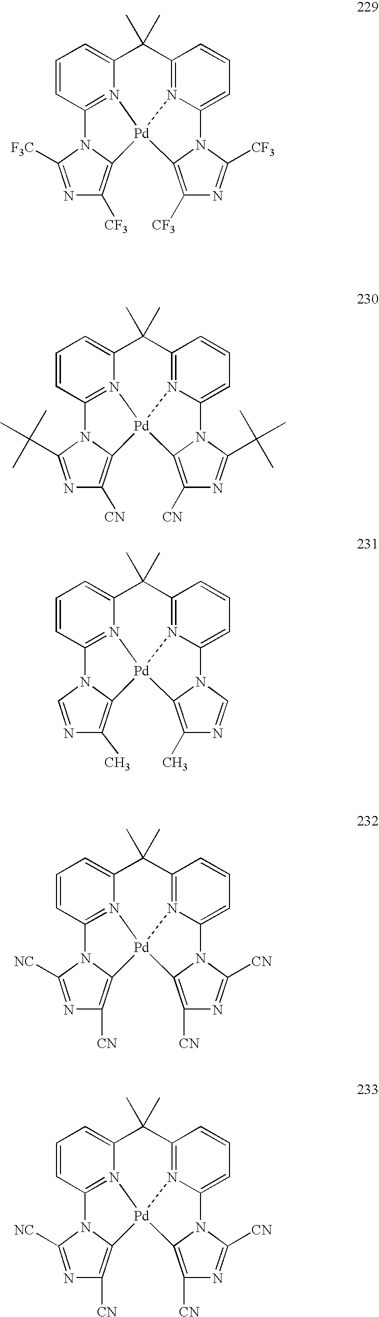

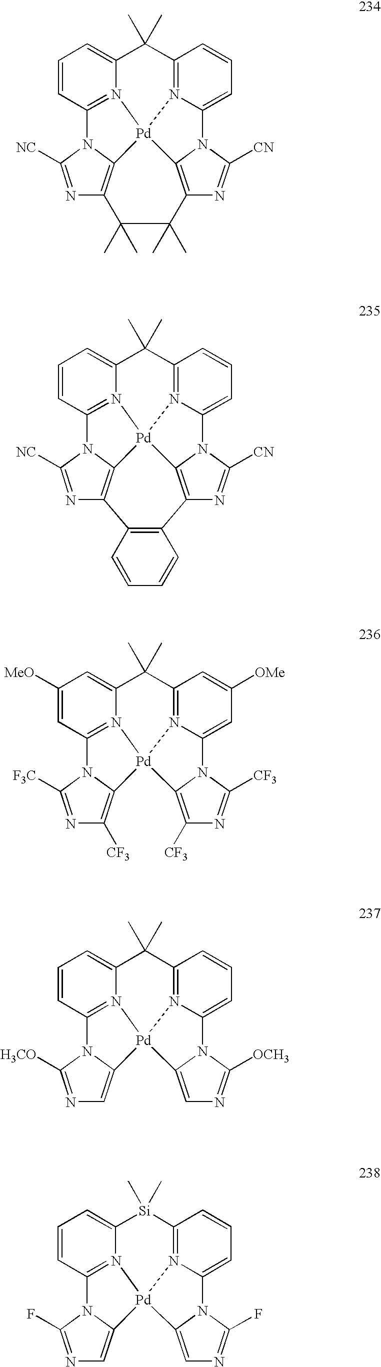

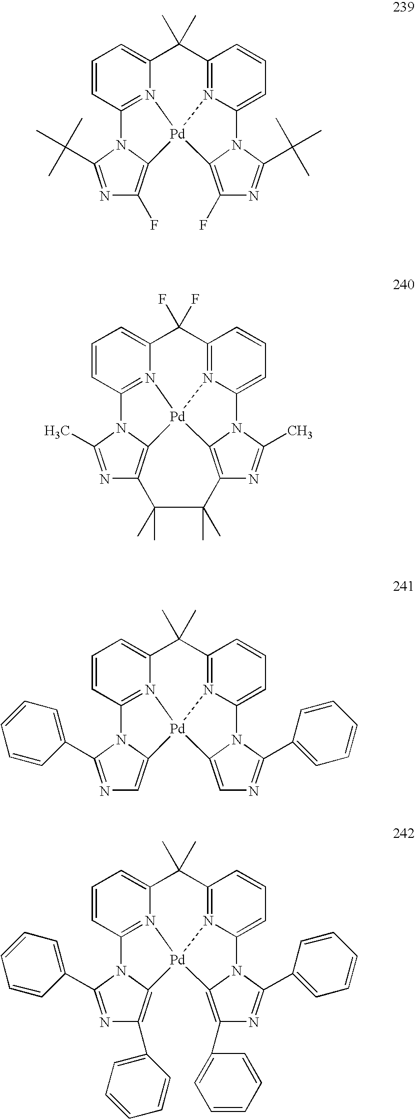

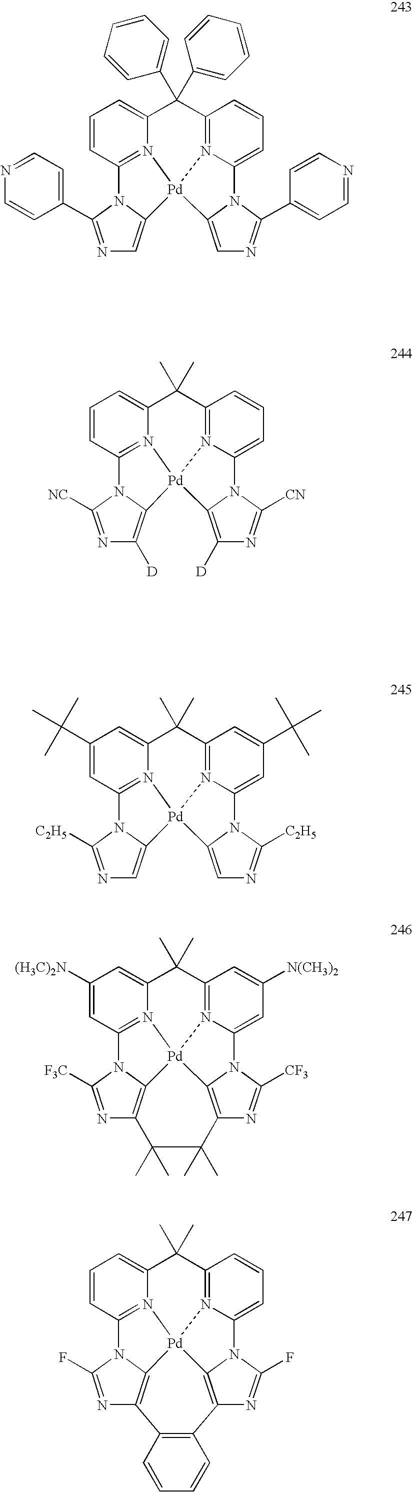

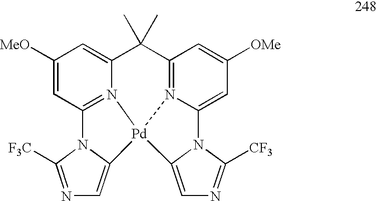

Next, individual elements constituting a device of the invention will be described in detail.

### <Substrate>

The substrate to be used in the invention is preferably a substrate causing neither scattering nor attenuation of the light emitted from the organic layer. Specific examples of materials of the substrate include inorganic substances such as yttrium-stabilized zirconia (YSZ) and glass, and organic substances such as polyesters, e.g., polyethylene terephthalate, polybutylene phthalate and polyethylene naphthalate, polystyrene, polycarbonate, polyether sulfone, polyarylate, polyimide, polycycloolefins, norbornene resins, polychlorotrifluoroethylene and so on.

In the case of using, for example, glass as the substrate, it is preferable concerning the material to use an alkali-free glass for minimizing ion elution from the glass. In the case of using soda lime glass, it is preferable to employ one having a barrier coating made of, for example, silica. In the case of using an organic material, it is preferable to select one excellent in heat resistance, dimensional stability, solvent resistance, electrical insulating properties, and processability.

The shape, structure, size, etc. of the substrate are not particularly limited and selected appropriately according to the intended use or purpose of the device. In general, the substrate has a plate shape and may have either a single layer structure or a multilayer structure. It may be made of a single member or two or more members.

Although the substrate may be either colorless and transparent or colored and transparent, a colorless and transparent substrate is preferred because of causing neither scattering nor attenuation of the light emitted from the organic layer.

The substrate may have a moisture barrier layer (or a gas barrier layer) formed on the front or back face thereof. Suitable materials for making the moisture harrier layer (gas barrier layer) include inorganic substances such as silicon nitride and silicon oxide. The moisture barrier layer (gas barrier layer) can be formed by, for example, RF sputtering. In the case of using a thermoplastic substrate, the substrate may further have a hard coat layer, an undercoat layer, etc. formed thereon, if necessary.

### <Anode>

The anode is usually not limited in shape, structure, size, etc. so as long as it has the function as an electrode supplying holes into the organic layer. The shape, structure, size, etc. are appropriately chosen from known electrode designs according to the intended use or purpose of the device. As described above, the anode is usually formed as a transparent anode.

Materials making up the anode include metals, alloys, metal oxides, electrically conductive compounds, and mixtures thereof. Specific examples of these materials include conductive metal oxides such as tin oxide doped with antimony, fluorine, etc. (e.g., ATO or FTO), tin oxide, zinc oxide, indium oxide, indium tin oxide (ITO), and indium zinc oxide (IZO); metals such as gold, silver, chromium, and nickel; mixtures or composite laminates composed of these metals and conductive metal oxides; inorganic conductive substances such as copper iodide and copper sulfide; organic conductive materials such as polyaniline, polythiophene, and polypyrrole; and composite laminates composed of these materials and ITO. Among all, ITO is preferred from the viewpoint of productivity, high conductivity, transparency and so on.

The anode can be formed on the substrate by a process properly selected according to suitability to the material from among wet processes such as printing and coating, physical processes such as vacuum deposition, sputtering and ion plating, and chemical processes such as CVD and plasma CVD. In the case of selecting ITO as the anode material, for instance, the anode can be formed by DC sputtering, RF sputtering, vacuum deposition, or ion plating.

The anode may be formed in any part of the organic electroluminescent device of the invention selected appropriately according to the intended use or purpose of the device without particular restriction. It is preferable to form the anode on the substrate. In such a case, the anode may be formed in a part of one face of the substrate or all over the same.

Methods of patterning the anode include chemical etching by photolithography or like techniques and physical etching with a laser beam, etc. Otherwise, the anode can be formed by vacuum deposition, sputtering or a like dry film formation process through a pattern mask, or by a lift-off method or a printing method.

The thickness of the anode cannot be generally specified, being subject to variation depending on the material. Usually, the thickness is 10 nm to 50 μm, preferably 50 nm to 20 μm.

The anode preferably has a resistivity of 10³ Ω/square or less, preferably 10² Ω/square or less. In the case where the anode is transparent, it may be either colorless and transparent or colored and transparent. To obtain luminescence from the transparent electrode, the transmittance thereof is preferably 60% or higher, still preferably 70% or higher.

Detailed illustration on transparent anodes is given in Tomei Denkyokumaku no Shintenkai, supervised by Yutaka Sawada, CMC (1999) which is applicable to the invention. In the case of using a plastic base having low heat resistance, it is desirable to employ ITO or IZO and form an anode film at a low temperature of 150° C. or below.

### <Cathode>

The cathode is usually not limited in shape, structure, size, etc. as long as it has the function as an electrode injecting electrons into the organic layer. The shape, structure, size, etc. are appropriately chosen from known electrode designs according to the intended use or purpose of the device.

Materials making up the cathode include metals, alloys, metal oxides, electrically conductive compounds, and mixtures thereof. Specific examples of such materials are alkali metals (e.g., Li, Na, K, and Cs), alkaline earth metals (e.g., Mg and Ca), gold, silver, lead, aluminum, sodium-potassium alloys, lithium-aluminum alloys, magnesium-silver alloys, and rare earth metals (e.g., indium and ytterbium). These materials can be used individually or as a combination of two or more thereof. A combined use is preferred for obtaining both stability and electron injection properties.

As the material for the cathode, alkali metals and alkaline earth metals are preferred from the aspect of electron injection, and aluminum-based materials are preferred from the aspect of storage stability.

The aluminum-based materials include aluminum and mixtures or alloys comprising aluminum and 0.01 to 10% by mass of an alkali metal or an alkaline earth metal, such as an aluminum-lithium alloy and an aluminum-magnesium alloy.

For more detailed information about the cathode materials, refer to JP-A-2-15595 and JP-A-5-121172, which are applicable to the invention.

The cathode can be formed by any known method with no particular restriction. Namely, it can be formed by a method properly selected according to suitability to the material from among wet processes such as printing and coating, physical processes such as vacuum deposition, sputtering and ion plating, and chemical processes such as CVD and plasma CVD. In the case of selecting a metal etc. as the cathode material, for instance, the cathode may be formed by simultaneously or successively sputtering one or more such materials.

Methods of patterning the cathode include chemical etching by photolithography and like techniques and physical etching with a laser beam, etc. Otherwise, the cathode can be formed by vacuum deposition, sputtering or a like thin film formation technique through a pattern mask, or by a lift-off method or a printing method.

The cathode may be formed in any part of the organic electroluminescent device of the invention without particular restriction. That is, the cathode may be formed in a part of the organic layer or all over the same.

A dielectric layer made of, for example, a fluoride of an alkali metal or an alkaline earth metal may be formed between the cathode and the organic layer to a thickness of 0.1 to 5 nm. This dielectric layer may be considered as an electron-injecting layer too. The dielectric layer can be formed by, for example, vacuum deposition, sputtering or ion plating.

The thickness of the cathode is subject to variation depending on the material and cannot be generally specified. Usually, the thickness is 10 nm to 5 μm, preferably 50 nm to 1 μm.

The cathode may be either transparent or opaque. A transparent cathode can be formed by forming a thin film (thickness: 1 to 10 nm) of a cathode material and laminating a transparent conductive material such as ITO or IZO as described above thereon.

### <Organic Layer>

Next, the organic layer in the invention will be illustrated. A device of the invention has at least one organic layer including a light-emitting layer. As organic layers other than the light-emitting layer, there can be enumerated a hole-transporting layer, an electron-transporting layer, a hole-blocking layer, an electron-blocking layer, a hole-injecting layer, an electron-injecting layer and so on, as discussed above.

### —Formation of Organic Layer—

In the organic electroluminescent device of the invention, each layer constituting the organic layers can be appropriately formed by any of dry film formation processes such as deposition and sputtering, transferring and printing.

### —Light-Emitting Layer—

The light-emitting layer is a layer which has the function of receiving holes from the anode, the hole-injecting layer or the hole-transporting layer, receiving electrons from the cathode, the electron-injecting layer or the electron-transporting layer and thus allowing re-binding of the holes to the electrons thereby emitting light, when voltage is applied.

The light-emitting layer in the invention may be made of a light-emitting material alone. Alternatively, it may be made of a mixture layer comprising a host material and a light-emitting material. The light-emitting material may be either a fluorescent material or a phosphorescent material. Either one or more dopants may be used. It is preferable that the host material is an electron-transporting material. Either one or more host materials may be used. For example, use may be made of a mixture of an electron-transporting host material with a hole-transporting host material. The light-emitting layer may further contain a material which has neither electron-transporting properties nor luminescence. As the light-emitting layer, one comprising a light-emitting material and the complex of the invention as the host material is preferred.

Either one or more light-emitting layers may be provided and individual layers may emit lights in different colors.

Examples of the fluorescent material usable in the invention include benzoxazole derivatives, benzoimidazole derivatives, benzothiazole derivatives, styrylbenzene derivatives, polyphenyl derivatives, diphenylbutadiene derivatives, tetraphenylbutadiene derivatives, naphthalimide derivatives, coumalin derivatives, fused aromatic compounds, perinone derivatives, oxadiazole derivatives, oxadine derivatives, aldazine derivatives, pyrralidine derivatives, cyclopentadiene derivatives, bis-styryl anthracene derivatives, quinacridone derivatives, pyrrolopyridine derivatives, thiadiazolopyridine derivatives, styrylamine derivatives, diketopyrrolopyrrole derivatives, aromatic dimethylidyne compounds, various metal complexes typified by metal complexes, rare earth element complexes or transition metal complexes of 8-quinolinol derivatives and pyrromethene derivatives, polymer compounds such as polythiophene, polyphenylene and polyphenylene vinylene derivatives, organic silane derivatives and so on.

Examples of the phosphorescent material usable in the invention include complexes having a transition metal atom or a lanthanoid atom.

As the transition metal atom, there can be enumerated ruthenium, rhodium, palladium, tungsten, rhenium, osmium, iridium and platinum, though the invention is not restricted thereto. Rhenium, iridium and platinum are preferred.

As the lanthanoid atom, there can be enumerated lanthanum, cerium, praseodymium, neodymium, samarium, europium, gadolinium, terbium, dysprosium, holmium, erbium, thulium, ytterbium and lutetium. Among these lanthanoid atoms, neodymium, europium and gadolinium are preferred.

As the ligand of the complex, there can be enumerated ligands described in, for example, G. Wilkinson et al. Comprehensive Coordination Chemistry, Pergamon Press, 1987; H. Yersin, Photochemistry and Photophysics of Coordination Compounds, Springer-Verlag, 1987; and Yamamoto Akio, Yukikinzokukagaku-kiso to ohyo, Shokabo Publishing Co., 1982.

Specific examples of the ligand include halogen ligands (preferably chlorine ligand), nitrogen-containing heterocyclic ligands (for example, phenylpyridine, benzoquinoline, quinolinol, bipyridyl, phenanthroline, etc.), diketone ligands (for example, acetylacetone, etc.), carboxylate ligand (for example, acetate ligand, etc.), a carbon monoxide ligand, an isonitrile ligand and a cyano ligand. Nitrogen-containing heterocyclic ligands are still preferred. Such a complex may have one transition metal atom in the compound. Alternatively, use may be made of a complex having two or more transition metal atoms, i.e., a so-called polynuclear complex. It may contain different metal atoms at the same time.

It is preferable that the phosphorescent material is contained in the light-emitting layer in an amount of from 0.1 to 40% by mass, more preferably from 0.5 to 20% by mass.

As the host material to be contained in the light-emitting layer in the invention, there can be enumerated, for example, those having a carbazole skeleton, those having a diarylamine skeleton, those having a pyridine skeleton, those having a pyrazine skeleton, those having a triazine skeleton and those having an arylsilane skeleton, and the materials which will be presented hereinafter as examples concerning the hole-injecting layer, the hole-transporting layer, the electron-injecting layer and the electron-transporting layer.

Although the thickness of the light-emitting layer is not particularly restricted, it preferably ranges from 1 nm to 500 nm, still preferably from 5 nm to 200 nm and still preferably from 10 nm to 100 nm.

### —Hole-Injecting Layer and Hole-Transporting Layer—

The hole-injecting layer and the hole-transporting layer are layers having the function of receiving holes from the anode or the anode side and transporting into the cathode side. More specifically speaking, it is preferable that the hole-injecting layer and hole-transporting layer are layers containing carbazole derivatives, triazole derivatives, oxazole derivatives, oxadiazole derivatives, imidazole derivatives, polyarylalkane derivatives, pyrazoline derivatives, pyrazolone derivatives, phenylenediamine derivatives, arylamine derivatives, amino-substituted chalcone derivatives, styrylanthrazene derivatives, fluorenone derivatives, hydrazone derivatives, stilbene derivatives, silazane derivatives, aromatic tertiary amine compounds, styrylamine compounds, aromatic dimethylidene compounds, porphyrin compounds, organosilane compounds, carbon and so on.

From the viewpoint of lowering the driving voltage, it is preferable that the hole-injecting layer and the hole-transporting layer have each a thickness of not more than 500 nm.

The thickness of the hole-transporting layer preferably ranges from 1 nm to 500 nm, still preferably from 5 nm to 200 nm and still preferably form 10 nm to 100 nm. The thickness of the hole-injecting layer preferably ranges from 0.1 nm to 200 nm, still preferably form 0.5 nm to 100 nm and still preferably from 1 nm to 100 nm.

The hole-injecting layer and the hole-transporting layer may have a single layer structure made of one or more materials as described above. Alternatively, they may have a multilayer structure composed of multiple layers of the same or different compositions.

### —Electron-Injecting Layer and Electron-Transporting Layer—

The electron-injecting layer and the electron-transporting layer are layers having the function of receiving electrons from the cathode or the cathode side and transporting into the anode side. More specifically speaking, it is preferable that the electron-injecting layer and the electron-transporting layer are layers containing triazole derivatives, oxazole derivatives, oxadiazole derivatives, imidazole derivatives, fluorenone derivatives, anthraquinodimethane derivatives, anthrone derivatives, diphenylquinone derivatives, thiopyran dioxide derivatives, carbodiimide derivatives, fluorenylidene methane derivatives, distyrylpyrazine derivatives, heterocyclic tetracarboxylic anhydrides such as naphthalene and perylene, phthalocyanine derivatives, various metal complexes typified by metal complexes of 8-quinollinol derivatives, metallo-phthalocyanines and metal complexes having benzoxazole or benzothiazole as a ligand, organosilane derivatives and so on.

From the viewpoint of lowering the driving voltage, it is preferable that the electron-injecting layer and the electron-transporting layer have each a thickness of not more than 500 nm.

The thickness of the electron-transporting layer preferably ranges from 1 nm to 500 nm, still preferably from 5 in to 200 nm and still preferably form 10 nm to 100 nm. The thickness of the electron-injecting layer preferably ranges from 0.1 nm to 200 nm, still preferably form 0.2 nm to 100 nm and still preferably from 0.5 nm to 50 nm.

The electron-injecting layer and the electron-transporting layer may have a single layer structure made of one or more materials as described above. Alternatively, they may have a multilayer structure composed of multiple layers of the same or different compositions.

### —Hole-Blocking Layer—

The hole-blocking layer is a layer which has the function of preventing the holes, that have been transported from the anode side to the light-emitting layer, from passing through toward the cathode side. In the invention, the hole-blocking layer can be provided as an organic layer adjacent to the light-emitting layer in the cathode side.

Examples of organic compounds constituting the hole-blocking layer include aluminum complexes such s BAlq, triazole derivatives, phenanthroline derivatives such as BCP and so on.

The thickness of the hole-blocking layer preferably ranges from 1 nm to 500 nm, still preferably form 5 nm to 200 nm and still preferably from 10 nm to 100 nm.

The hole-blocking layer may have a single layer structure made of one or more materials as described above. Alternatively, it may have a multilayer structure composed of multiple layers of the same or different compositions.

### <Protective Layer>

In the invention, the whole organic EL element may be protected with a protective layer.

The protective layer may contain any materials that prevent the invasion of substances accelerating deterioration of the device, such as moisture and oxygen, into the device.

Specific examples of such materials include metals such as In, Sn, Pb, Au, CU, Ag, AL, Ti and Ni, metal oxides such as MgO, SiO, SiO₂, Al₂O₃, GeO, NiO, CAO, BaO, Fe₂O₃, Y₂O³ and TiO₂, metal nitrides such as SiNₓ and SiNₓO_{y}, metal fluorides such as MgF₂, LiF, AlF₃ and CaF₂, polyethylene, polypropylene, polymethyl methacrylate, polyimide, polyurea, polytetrafluoroethylene, polychlorotrifluoroethylene, polydichlorodifluoroethylene, chlorotrifluoroethylene/dichlorodifluoroethylene copolymer, a copolymer obtained by copolymerizing a monomer mixture containing tetrafluoroethylene and at least one comonomer, a fluorine-containing copolymer having a cyclic structure in the copolymer main chain, a moisture-absorbing substance having a moisture absorptivity of 1% or higher, a moisture-proof substance having a moisture absorptivity of 1% or lower and so on.

Methods for forming the protective layer include, but are not limited to, vacuum evaporation, sputtering, reactive sputtering, MBE (molecular beam epitaxial growth), cluster ion beam-assisted deposition, ion plating, plasma polymerization (high-frequency excitation ion plating), plasma-enhanced CVD, laser-assisted CVD, thermal CVD, gas source CVD, coating, printing and transferring.

### <Sealing>

The device of the invention may be sealed as a whole by using a sealing container. The space between the sealing container and the device may be filled with a moisture absorber or an inert liquid. The moisture absorber includes, but is not limited to, barium oxide, sodium oxide, potassium oxide, calcium oxide, sodium sulfate, calcium sulfate, magnesium sulfate, phosphorus pentaoxide, calcium chloride, magnesium chloride, copper chloride, cesium fluoride, niobium fluoride, calcium bromide, vanadium bromide, molecular sieve, zeolite, magnesium oxide and so on. The inert liquid includes, but is not limited to, paraffins, liquid paraffins, fluorine-containing solvents such as perfluoroalkanes, perfluoroamines and perfluoroethers, chlorine-containing solvents, silicone oils and so on.

The device of the invention emits light on applying a DC (which may contain, if desired, an alternating component) voltage (usually 2 to 15 V) or a DC current between the anode and the cathode.

For driving the device of the invention, the methods described in JP-A-2-149687, JP-A-6-301355, JP-A-5-29080, JP-A-7-134558, JP-A-8-234685, JP-A-8-241047, Japanese Patent No. 2784615 and U.S. Pat. Nos. 5,828,429 and 6,0233,308 can be made use of.

The device of the invention is appropriately usable in display devices, displays, backlights, electrophotography, light sources for illumination, light sources for recording, light sources for exposure, light sources for reading, indications, signboards, interior accessories, optical transmission systems and the like.

The complex of the invention can be produced by, for example, the following method. Next, a method for producing a compound represented by the formula (IIC) in practice will be described.

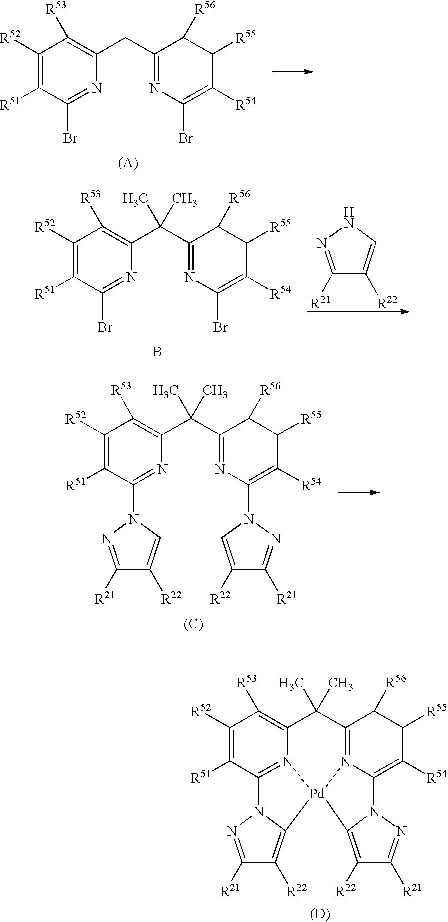

In the above formulae, R²¹s, R²²s, R⁵¹, R⁵², R⁵³, R⁵⁴, R⁵⁵ and R⁵⁶ independently represent each a hydrogen atom or a substituent. The complex of the invention can be obtained by a method described in Journal of Organic Chemistry, 53, 786 (1988), G. R. Newkome et al., p. 789, left column line 53 to right column line 7, a method described in p. 790, right column lines 19 to 30 and a combination of these methods. Starting with the compound (A), 1 to 1.2 equivalent, based on N,N-dimethylformamide solution of (A), of a base such as lithium diisopropylamide, potassium t-butoxide or sodium hydride is added and the resultant mixture is reacted at 0° C. to room temperature for about 30 minutes. Next, 1.5 to 4 equivalents of methyl iodide is added thereto and the mixture is reacted at room temperature for about 30 minutes to conduct monomethylation. Subsequently, 1 to 1.2 equivalent of the above-described base is reacted with methyl iodide in excess under the same conditions. Thus, a dimethylated compound (B) can be obtained at a yield of from 70 to 99%.

The process for obtaining (C) from (B) can be carried out in accordance with a synthesis method described in Chemische Berichte 113, 2749 (1980), H. Lexy et al., p. 2752, lines 26 to 35.

The process for obtaining the compound (D) of the invention from (C) can be carried out by dissolving the compound (C) and 1 to 1.5 equivalent of bis(acetonitrile)dichloropalladium in trimethyl phosphate, heating the mixture at 100° C. to the reflux temperature, and stirring for 30 minutes to 12 hours. The compound (D) can be purified by recrystallization from chloroform or ethyl acetate, silica gel column chromatography, sublimation, etc.

In the case where a substituent defined in the above method undergoes a change under specific synthesis conditions or is inappropriate for the embodiment of the method, production can be easily conducted by using techniques for protecting or deprotecting a functional group (see, for example, Protective Groups in Organic Synthesis, T.W. Greene, John Wiley & Sons Inc., 1981). If necessary, it is also possible to appropriately change the order of the reaction steps, for example, introduction of a substituent.

### EXAMPLES

Next, the invention will be illustrated in greater detail by reference to the following Examples. However, it is to be understood that the invention is not restricted thereto.

### Synthesis Example

### Synthesis of Compound 4

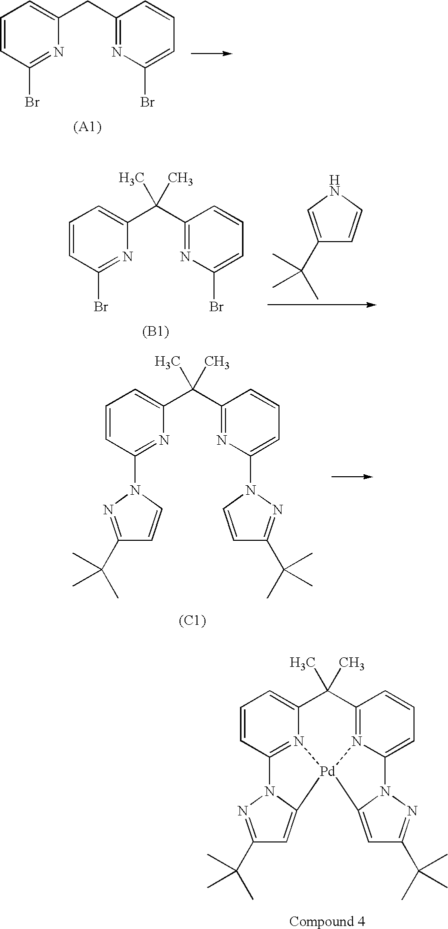

### (Synthesis of Compound B1)

Under a nitrogen gas stream, the compound A1 (18.6 g) was dissolved in 90 ml of N,N-dimethylformamide. After cooling to 0° C., potassium t-butoxide (6.8 g, 1.05 equivalent) was added thereto and the resultant mixture was heated to room temperature and stirred for 30 minutes. After cooling to 0° C. again, methyl iodide (7.2 ml, 1.82 equivalent) was added and the reaction was heated to room temperature and stirred for 30 minutes to conduct monomethylation. This procedure was repeated again to conduct dimethylation. Then, the reaction mixture was extracted with ethyl acetate and washed with water and a saturated aqueous solution of sodium chloride. The organic layer was dried over magnesium sulfate and ethyl acetate was distilled off. The crude product thus obtained was purified by silica gel column chromatography (hexane:ethyl acetate=20:1) to give 18.6 g (yield 92.1%) of the compound B1 as colorless crystals.

### (Synthesis of Ligand (C1))

Under a nitrogen gas stream, the compound B1 (3.82 g, 11 mmol), t-butylpyrazole (4.00 g, 32 mmol), potassium carbonate (8.84 g, 64 mmol) and copper iodide (0.42 g, 2.2 mmol) were suspended in 80 ml of nitrobenzene. Under stirring, the water-bath temperature was heated to 185° C. (internal temperature 170° C.). After stirring under heating for 6 hours, the mixture was cooled to room temperature. The insoluble matters were filtered off through Celite and the solvent in the filtrate was distilled off under reduced pressure. The residue was purified with the use of a silica gel column (hexane:ethyl acetate=95:5) to give 3.9 g (yield 80%) of the compound 1 as pale yellow crystals.

### (Synthesis of Compound 4)

Under a nitrogen gas stream, the compound C1 (3.5 g, 7.9 mmol) and bis(acetonitrile)palladium (II) dichloride (2.25 g, 8.7 mmol) were suspended in 200 ml of trimethyl phosphate. Under stirring, the temperature of the water-bath was elevated to 120° C. After stirring under heating for 11 hours, the mixture was cooled to room temperature. The precipitate thus formed was collected by filtration and washed with methanol to give a crude product. By purifying with the use of a silica gel column (ethyl acetate), 1.2 g (yield 28%) of the compound 4 was obtained as crystals.

¹H-NMR (CDCl₃): δ(ppm)=7.84 (t, J=8.0 Hz, 2H), 7.68 (dd, J=0.8, 8.1 Hz, 2H), 7.24 (dd, J=0.8, 8.1 Hz, 2H), 6.44 (s, 3H), 1.92 (s, 6H), 1.40 (s, 18H)

### Comparative Example 1

### Device Described in JP-A-2004-221065

A washed ITO substrate was put into a deposition device and TPD (N,N′-diphenyl-N,N′-di(tolyl)-benzidine) was deposited thereon to give thickness of 50 nm. Further, the compound (1-24) reported in JP-A-2004-221065 and Ir(ppy)₃ were deposited at a ratio of 17:1 (by mass) thereon to give a thickness of 36 nm and the compound A was deposited thereon to give a thickness of 36 nm. Moreover, lithium fluoride was deposited thereon to give a thickness of about 1 nm and aluminum was deposited to give a thickness of 200 nm to give a cathode, thereby constructing a device. A DC voltage was applied to the EL device by using a Source-Measure Unit Model 2400 supplied by Toyo Corp. to induce light-emitting. As a result, green-light emission derived from Ir(ppy)₃ was obtained.

### Comparative Example 2

A washed ITO substrate was put into a deposition device and copper phthalocyanine was deposited thereon to give thickness of 10 nm. Then, NPD (N,N′-di-α-naphthyl-N,N′-diphenyl)-benzidine) was deposited thereon to give a thickness of 20 nm. Further, mCP and the compound B were deposited at a ratio of 90:10 (by mass) thereon to give a thickness of 36 nm. Furthermore, BAlq was deposited thereon to give a thickness of 10 nm and Alq (tris(8-hydroxyquinoline)aluminum complex) was deposited thereon to give a thickness of 40 nm. Moreover, lithium fluoride was deposited thereon to give a thickness of 3 nm and aluminum was deposited to give a thickness of 60 nm, thereby constructing a device. A DC voltage was applied to the EL device by using a Source-Measure Unit Model 2400 supplied by Toyo Corp. to induce light-emitting. As a result, bluish green-light emission derived from the compound B was obtained.

Next, the chemical structures of TPD, (1-24), Ir(ppy)₃, the compound A, NPD, mCP, the compound B, Balq and Alq as described above will be presented.

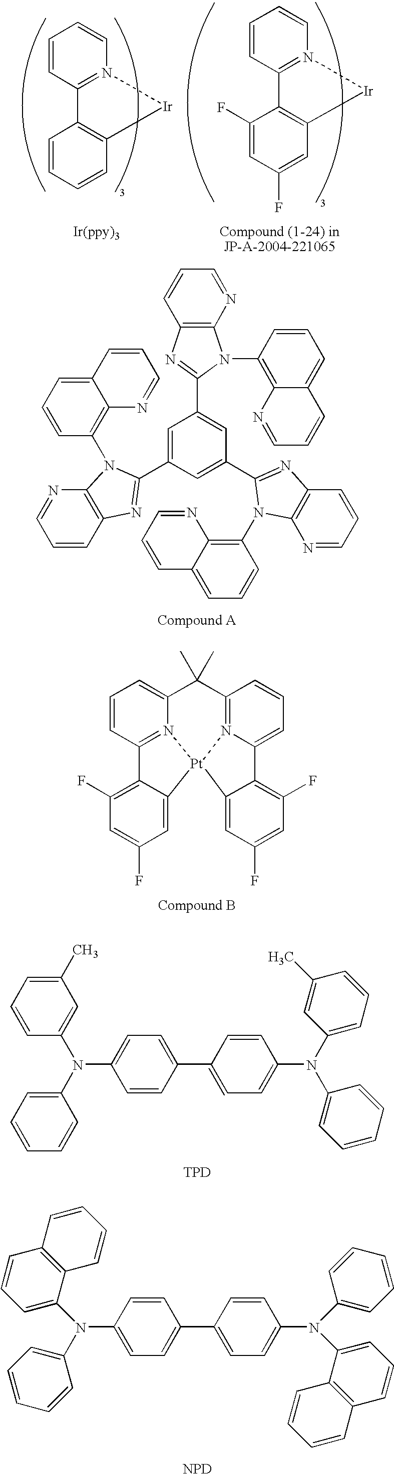

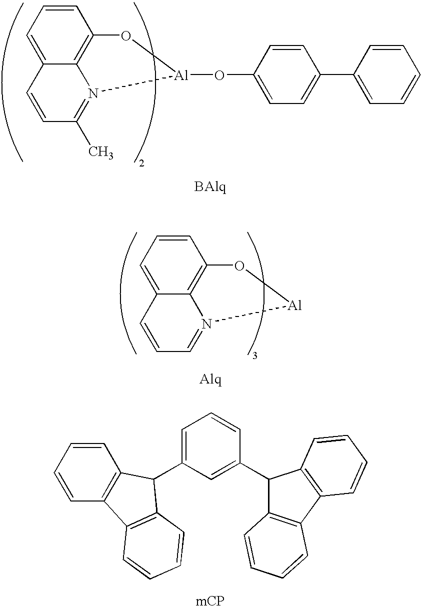

### Example 1

A device was constructed and evaluated as in Comparative Example 1 but using the compound 4 as a substitute for the compound (1-24) in JP-A-2004-221065. As a result, green-light emission derived from Ir(ppy)₃ was obtained. When driven at 1 mA (light-emitting area 4 mm²), the luminance half-life of the device was 2.2 times as long as that of the device of Comparative Example 1.

### Example 2

A washed ITO substrate was put into a deposition device and copper phthalocyanine was deposited thereon to give thickness of 10 nm. Then, NPD (N,N′-di-α-naphthyl-N,N′-diphenyl)-benzidine) was deposited thereon to give a thickness of 20 nm. Further, mCP and the compound 4 and the compound B of the invention were deposited at a ratio of 70:20:1 (by mass) thereon to give a thickness of 36 nm. Furthermore, BAlq was deposited thereon to give a thickness of 10 nm and Alq (tris(8-hydroxyquinoline)aluminum complex) was deposited thereon to give a thickness of 40 nm. Moreover, lithium fluoride was deposited thereon to give a thickness of 3 nm and aluminum was deposited to give a thickness of 60 nm, thereby constructing a device. ADC voltage was applied to the EL device by using a Source-Measure Unit Model 2400 supplied by Toyo Corp. to induce luminescence. As a result, bluish green-light emission derived from the compound B was obtained. When driven at 1 mA (light-emitting area 4 mm²), the luminance half-life of the device was 2.4 times as long as that of the device of Comparative Example 2. The voltage required for passing the currency of 1 mA (light-emitting area 4 mm²) was lower by about 1 V.

By using devices using other compounds of the invention, highly durable organic electroluminescent devices can be also constructed.

### INDUSTRIAL APPLICABILITY

According to one aspect of the invention, an organic electroluminescent device (hereinafter used in the same meaning as “device of the invention”) having an excellent durability can be provided.

It will be apparent to those skilled in the art that various modifications and variations can be made to the described embodiments of the invention without departing from the spirit or scope of the invention. Thus, it is intended that the invention cover all modifications and variations of this invention consistent with the scope of the appended claims and their equivalents.

The present application claims foreign priority based on Japanese Patent Application No. JP2005-274248 filed Sep. 21 of 2005, the contents of which are incorporated herein by reference.

1. An organic electroluminescent device comprising:
a pair of electrodes; and
at least one organic layer between the pair of electrodes, the at least one organic layer containing a compound represented by formula (I): 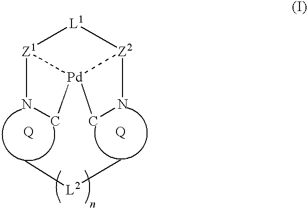
wherein Z¹ and Z² each independently represent an atom group coordinating with palladium; Q represents a nitrogen-containing heterocycle; L¹ and L² each independently represent a single bond or a divalent linking group; and n is 0 or 1.

2. The organic electroluminescent device according to claim 1, wherein the compound represented by formula (I) is a compound represented by formula (II): 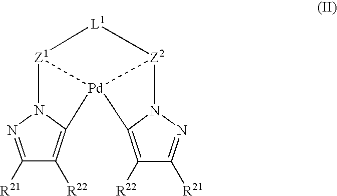
wherein Z¹, Z² and L¹ are the same as those defined in formula (I); and R²¹s and R²²s each independently represent a hydrogen atom or a substituent.

3. The organic electroluminescent device according to claim 1, wherein the compound represented by formula (I) is a compound represented by formula (III): 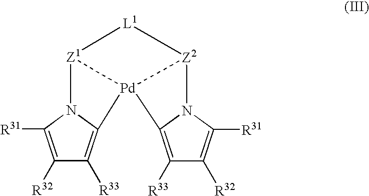
wherein Z¹, Z² and L¹ are the same as those defined in formula (I); and R³¹s, R³²s and R³³s each independently represent a hydrogen atom or a substituent.

4. The organic electroluminescent device according to claim 1, wherein the compound represented by formula (I) is a compound represented by formula (IV): 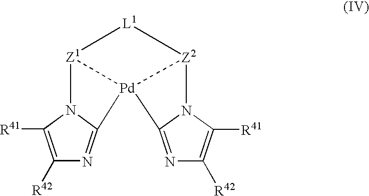
wherein Z¹, Z² and L¹ are the same as those defined in formula (I); and R⁴¹s and R⁴²s each independently represent a hydrogen atom or a substituent.

5. The organic electroluminescent device according to claim 2, wherein the compound by formula (II) is a compound represented by formula (IIA): 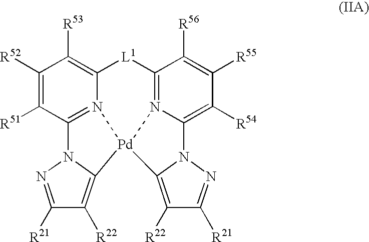
wherein L¹ represents a single bond or a divalent linking group; and R²¹s, R²²s, R⁵¹, R⁵², R⁵³, R⁵⁴, R⁵⁵ and R⁵⁶ each independently represent a hydrogen atom or a substituent.

6. The organic electroluminescent device according to claim 5, wherein the compound represented by formula (IIA) is a compound represented by formula (IIB): 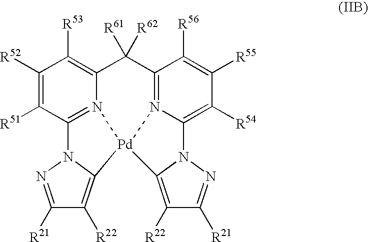
wherein R²¹s, R²²s, R⁵¹, R⁵², R⁵³, R⁵⁴, R⁵⁵, R⁵⁶, R⁶¹ and R⁶² each independently represent a hydrogen atom or a substituent.

7. The organic electroluminescent device according to claim 6, wherein the compound represented by formula (IIB) is a compound represented by formula (IIC): 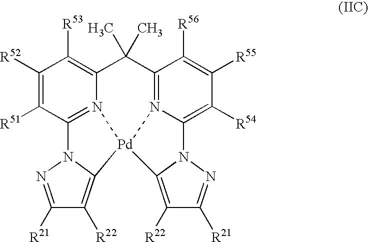
wherein R²¹s, R²²s, R⁵¹, R⁵², R⁵³, R⁵⁴, R⁵⁵ and R⁵⁶ each independently represent a hydrogen atom or a substituent.

8. The organic electroluminescent device according to claim 7, wherein the compound represented by formula (IIC) is a compound represented by formula (IID): 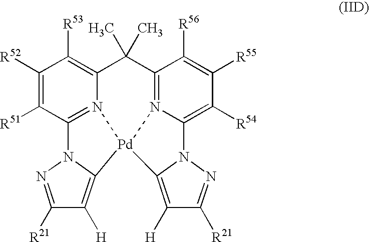
wherein R⁵¹, R⁵², R⁵³, R⁵⁴, R⁵⁵ and R⁵⁶ each independently represent a hydrogen atom or a substituent; and R²¹s each represent a substituent.

9. The organic electroluminescent device according to claim 2, wherein the substituent is a substituent selected from the group consisting of an alkyl group having from 1 to 20 carbon atoms, an alkenyl group having from 2 to 10 carbon atoms, an aryl group having from 6 to 20 carbon atoms, an amino group having from 0 to 20 carbon atoms, an alkoxy group having from 1 to 20 carbon atoms, an aryloxy group having from 6 to 20 carbon atoms, an acyl group having form 1 to 20 carbon atoms, an alkoxycarbonyl group having from 2 to 20 carbon atoms, an alkylthio group having from 1 to 20 carbon atoms, a sulfonyl group having from 1 to 20 carbon atoms, a hydroxy group, a halogen atom, a cyano group, a nitro group and a 5- to 7-membered heterocycle.

10. A compound represented by formula (IIA): 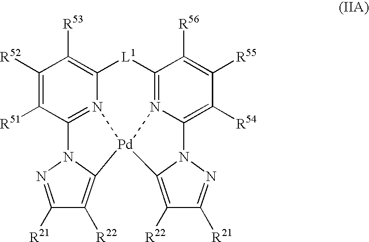
wherein L¹ represents a single bond or a divalent linking group; and R²¹s, R²²s, R⁵¹, R⁵², R⁵³, R⁵⁴, R⁵⁵ and R⁵⁶ each independently represent a hydrogen atom or a substituent.

11. The compound according to claim 10, wherein R²¹s, R²²s, R⁵¹, R⁵², R¹³, R⁵⁴, R⁵⁵ and R⁵⁶ each independently represent a substituent selected from the group consisting of an alkyl group having from 1 to 20 carbon atoms, an alkenyl group having from 2 to 10 carbon atoms, an aryl group having from 6 to 20 carbon atoms, an amino group having from 0 to 20 carbon atoms, an alkoxy group having from 1 to 20 carbon atoms, an aryloxy group having from 6 to 20 carbon atoms, an acyl group having form 1 to 20 carbon atoms, an alkoxycarbonyl group having from 2 to 20 carbon atoms, an alkylthio group having from 1 to 20 carbon atoms, a sulfonyl group having from 1 to 20 carbon atoms, a hydroxy group, a halogen atom, a cyano group, a nitro group and a 5- to 7-membered heterocycle.

12. The organic electroluminescent device according to claim 1, wherein Q represents one of pyrazole, pyrrole, and imidazole.
